(19) United States
(12) Patent Application Publication
(10) Pub. No.: US 2026/0186256 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventors: Xuepeng Zhou, Changzhou (CN); Shunda Zhou, Changzhou (CN)

(21) Appl. No.: 19/333,411

(22) Filed: Sep. 19, 2025

Related U.S. Application Data
(63) Continuation of application No. PCT/CN2024/144650, filed on Dec. 31, 2024.

(51) Int. Cl. G02B 13/00; G02B 1/04; G02B 9/64

(52) U.S. Cl. CPC G02B 13/0045; G02B 9/64; G02B 1/041

(57) ABSTRACT

A camera optical lens includes seven lenses sequentially from an object side to an image side: a first lens with positive refractive power, a second lens with negative refractive power, a third lens, a fourth lens with negative refractive power, a fifth lens, a sixth lens with positive refractive power, and a seventh lens with negative refractive power. Following relational expressions are satisfied: 1.40≤(f6−f7)/f≤1.70; 2.00≤R14/R13≤6.00; and 60.00≤v1≤82.00. The camera optical lens has good optical performance and characteristics of large aperture, wide-angle, and ultra-thinness, and is particularly suitable for a mobile phone camera lens assembly and a WEB camera lens composed of camera elements such as CCD, CMOS with high resolution.

### TECHNICAL FIELD

The present disclosure relates to the field of optical lenses, and in particular, to a camera optical lens suitable for handheld terminal devices such as smart phones, digital cameras, and camera devices such as monitors and PC lenses.

### BACKGROUND

In recent years, with the rise of various smart devices, the demand for a miniaturized camera optical lens has gradually increased. Since pixel size of the optical sensor is reduced, and the current electronic product has a development trend of light weight, thinness and being portable, the miniaturized camera optical lens with good imaging quality has become a mainstream of the current market. In order to obtain better imaging quality, a multi-lens structure is mostly used. In addition, with the development of technology and the increase of user's diversified requirements, under the condition that the pixel area of the optical sensor is continuously reduced and the requirements on the imaging quality of the system are continuously improved, a structure with seven lenses gradually appears in the lens design. There is an urgent need for a wide-angle camera lens with excellent optical performance, small size, and sufficiently corrected aberrations.

### SUMMARY

In view of the above problems, a main object of the present disclosure is to provide a camera optical lens, which has good optical performance and meets design requirements of large aperture, ultra-thinness and wide-angle.

In order to solve the above technical problem, the present disclosure provides a camera optical lens. The camera optical lens includes seven lenses sequentially from an object side to an image side: a first lens with positive refractive power, a second lens with negative refractive power, a third lens, a fourth lens with negative refractive power, a fifth lens, a sixth lens with positive refractive power, and a seventh lens with negative refractive power; a focal length of the camera optical lens is f, a focal length of the sixth lens is f6, a focal length of the seventh lens is f7, a central curvature radius of an object-side surface of the seventh lens is R13, a central curvature radius of an image-side surface of the seventh lens is R14, an Abbe number of the first lens L1 is v1, and following relational expressions are satisfied:

$$1.4 \leq ( f 6 - f 7 ) / f \leq 1.7 ;$$

$$2. \leq R 14 / R 13 \leq 6. ; and$$

$$60. \leq v 1 \leq 82. .$$

As an improvement, a central curvature radius of the object side surface of the second lens is R3, a central curvature radius of the image side surface of the second lens is R4, and a following relational expression is satisfied:

$$2.3 \leq ( R 3 + R 4 ) / ( R 3 - R 4 ) \leq 10. .$$

As an improvement, an on-axis thickness of the third lens is d5, an on-axis thickness of the fourth lens is d7, and a following relational expression is satisfied:

$$0.8 \leq d 5 / d 7 \leq 2. .$$

As an improvement, an object-side surface of the first lens is convex in a paraxial region, and an image-side surface of the first lens is concave in the paraxial region;
a focal length of the first lens is f1, a central curvature radius of an object-side surface of the first lens is R1, a central curvature radius of an image-side surface of the first lens is R2, an on-axis thickness of the first lens is d1, a total optical length from the object-side surface of the first lens to an image plane of the camera optical lens along an optic axis of the camera optical lens is TTL, and following relational expressions are satisfied:

$$0.69 \leq f 1 / f \leq 1.03 ;$$

$$- 2.66 \leq ( R 1 + R 2 ) / ( R 1 - R 2 ) \leq - 1.84 ; and$$

$$0.07 \leq d 1 / TTL \leq 0.15 .$$

As an improvement, an object-side surface of the second lens is convex in a paraxial region, and an image-side surface of the second lens is concave in the paraxial region;
a focal length of the second lens is f2, an on-axis thickness of the second lens is d3, the total optical length from the object-side surface of the first lens to an image plane of the camera optical lens along an optic axis of the camera optical lens is TTL, and following relations are satisfied:

$$- 6.9 \leq f 2 / f \leq - 2.34 ; and$$

$$0.03 \leq d 3 / TTL \leq 0.04 .$$

As an improvement, a focal length of the third lens is f3, a central curvature radius of an object-side surface of the third lens is R5, a central curvature radius of an image-side surface of the third lens is R6, an on-axis thickness of the third lens is d5, the total optical length from the object-side surface of the first lens to an image plane of the camera optical lens along an optic axis of the camera optical lens is TTL, and following relations are satisfied:

$$- 6.08 \leq f 3 / f \leq 13.84 ;$$

$$- 5.96 \leq ( R 5 + R 6 ) / ( R 5 - R 6 ) \leq - 0.74 ; and$$

$$0.03 \leq d 5 / TTL \leq 0.08 .$$

As an improvement, an image-side surface of the fourth lens is concave in a paraxial region;
a focal length of the fourth lens is f4, a central curvature radius of an object-side surface of the fourth lens is R7, a central curvature radius of an image-side surface of the fourth lens is R8, an on-axis thickness of the fourth lens is d7, the total optical length from the object-side surface of the first lens to an image plane of the camera optical lens along an optic axis of the camera optical lens is TTL, and following relations are satisfied:

$$- 5.46 \leq f 4 / f \leq - 2 \text{.12} ; \\ 0.81 \leq ( R 7 + R 8 ) / ( R 7 - R 8 ) \leq 3.77 ; and \\ 0.02 \leq d 7 / TTL \leq 0.05 .$$

As an improvement, an object-side surface of the fifth lens is concave in a paraxial region, and an image-side surface of the fifth lens is convex in the paraxial region;
a focal length of the fifth lens is f5, a central curvature radius of an object-side surface of the fifth lens is R9, a central curvature radius of an image-side surface of the fifth lens is R10, an on-axis thickness of the fifth lens is d9, the total optical length from the object-side surface of the first lens to an image plane of the camera optical lens along an optic axis of the camera optical lens is TTL, and following relations are satisfied:

$$- 57.4 \leq f 5 / f \leq 112.29 ; \\ - 3.61 \leq ( R 9 + R 10 ) / ( R 9 - R 10 ) \leq 1.85 ; and \\ 0.06 \leq d 9 / TTL \leq 0.09 .$$

As an improvement, an object-side surface of the sixth lens is convex in a paraxial region, and an image-side surface of the sixth lens is concave in the paraxial region;
a central curvature radius of an object-side surface of the sixth lens is R11, a central curvature radius of an image-side surface of the sixth lens is R12, an on-axis thickness of the sixth lens is d11, the total optical length from the object-side surface of the first lens to an image plane of the camera optical lens along an optic axis of the camera optical lens is TTL, and following relations are satisfied:

$$0.68 \leq f 6 / f \leq 0 \text{.95} ; \\ - 1.41 \leq ( R 11 + R 12 ) / ( R 11 - R 12 ) \leq - 1.01 ; and \\ 0.01 \leq d 11 / TTL \leq 0.62 .$$

As an improvement, the object-side surface of the seventh lens is concave in a paraxial region, and the image-side surface of the seventh lens is convex in the paraxial region;
an on-axis thickness of the seventh lens is d13, a total optical length from the object-side surface of the first lens to an image plane of the camera optical lens along an optic axis of the camera optical lens is TTL, and following relations are satisfied:

$$- 0.90 \leq f 7 / f \leq - 0 \text{.55} ; \\ - 2.97 \leq ( R 13 + R 14 ) / ( R 13 - R 14 ) \leq - 1.5 ; and \\ 0.07 \leq d 13 / TTL \leq 0.14 .$$

As an improvement, the second lens is made of glass.

The present disclosure has following beneficial effects: the camera optical lens as described in the present disclosure has good optical performance and characteristics of large aperture, wide-angle, and ultra-thinness, and is particularly suitable for a mobile phone camera lens assembly and a WEB camera lens composed of camera elements such as CCD, CMOS with high resolution.

### BRIEF DESCRIPTION OF DRAWINGS

In order to more clearly illustrate technical solutions of Examples of the present disclosure, the drawings to be used in the Examples will be briefly described below. Obviously, the drawings in the following description are some Examples of the present disclosure. For those skilled in the art, other drawings may also be obtained based on these drawings. In which:

FIG. 1 is a structural schematic diagram of a camera optical lens according to Example 1 of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a structural schematic diagram of a camera optical lens according to Example 2 of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a structural schematic diagram of a camera optical lens according to Example 3 of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a structural schematic diagram of a camera optical lens according to Example 4 of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a structural schematic diagram of a camera optical lens according to Example 5 of the present disclosure;

FIG. 18 is a schematic diagram of longitudinal aberration of the camera optical lens shown in FIG. 17;

FIG. 19 is a schematic diagram of lateral color of the camera optical lens shown in FIG. 17;

FIG. 20 is a schematic diagram of field curvature and distortion of the camera optical lens shown in FIG. 17;

FIG. 21 is a structural schematic diagram of a camera optical lens according to Comparative Example of the present disclosure;

FIG. 22 is a schematic diagram of longitudinal aberration of the camera optical lens shown in FIG. 21;

FIG. 23 is a schematic diagram of lateral color of the camera optical lens shown in FIG. 21; and

FIG. 24 is a schematic diagram of field curvature and distortion of the camera optical lens shown in FIG. 21.

### DESCRIPTION OF EXAMPLES

In order to more clearly illustrate objectives, technical solutions, and advantages of embodiments of the present disclosure, the following will provide a detailed description of various embodiments of the present disclosure in combination with the drawings. However, it should be understood by those skilled in the art that in each embodiment of the present disclosure, many technical details are presented to help readers better understand the present disclosure. However, even without these technical details and various changes and modifications based on the following embodiments, the technical solutions required to be protected by the present disclosure can still be achieved.

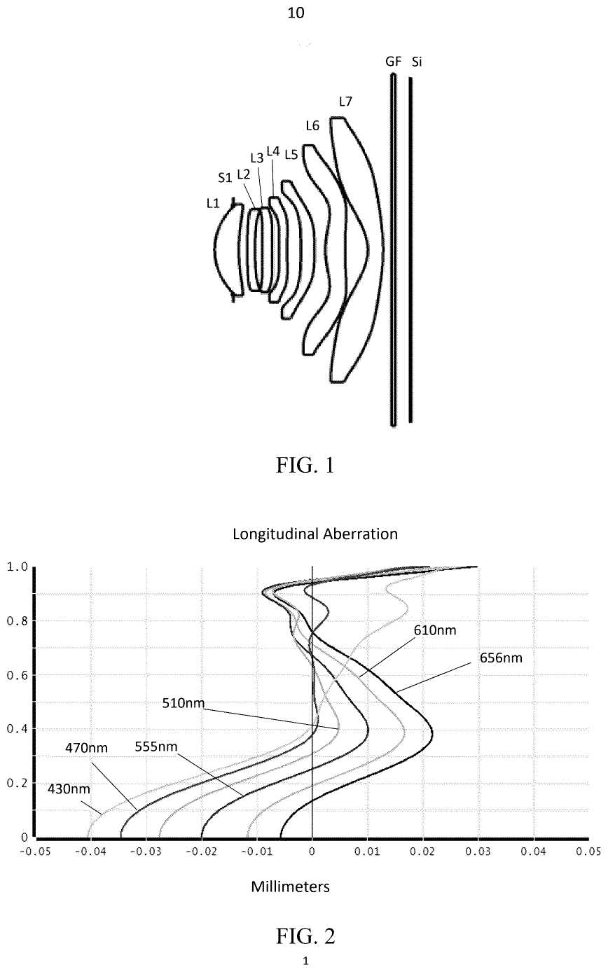

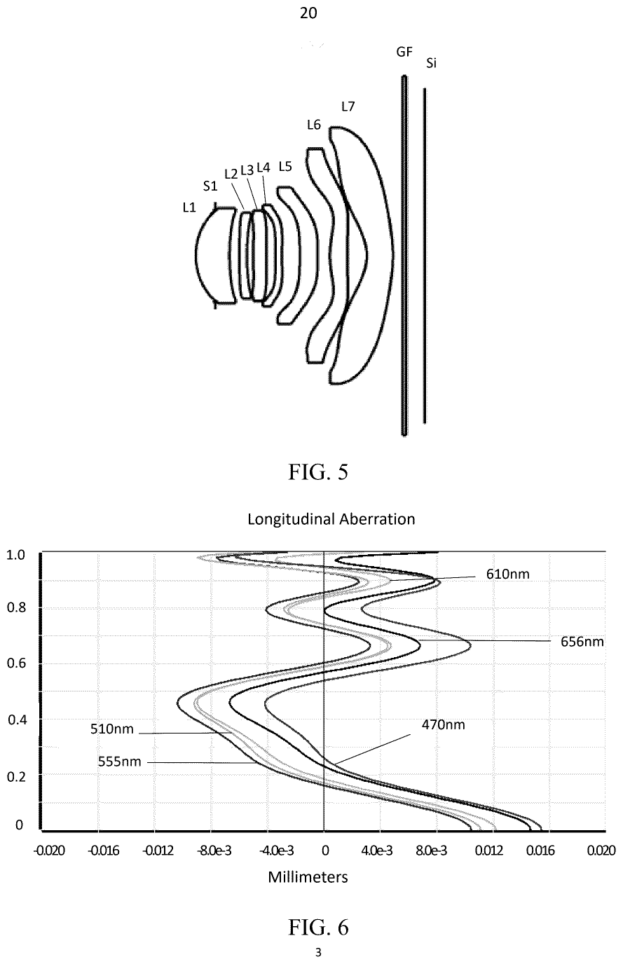

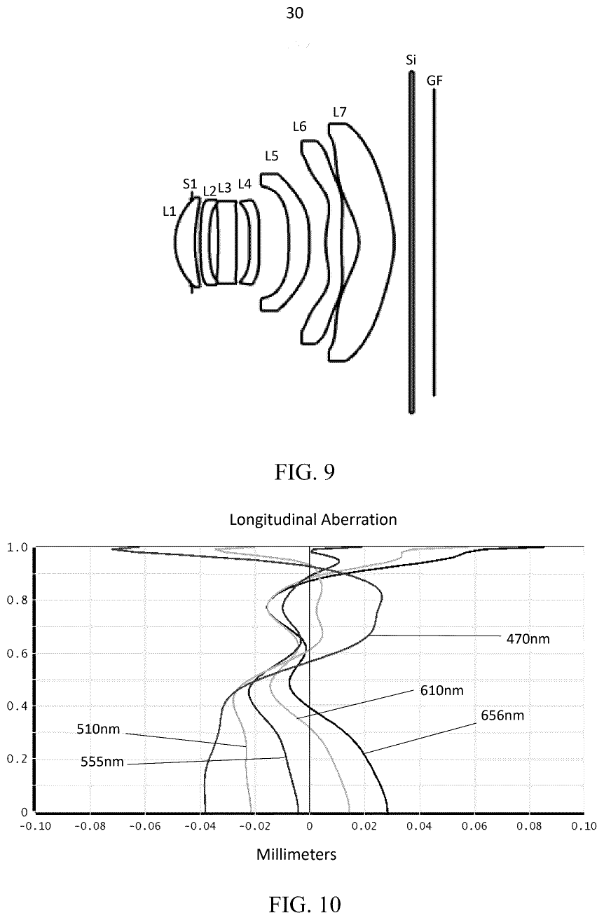

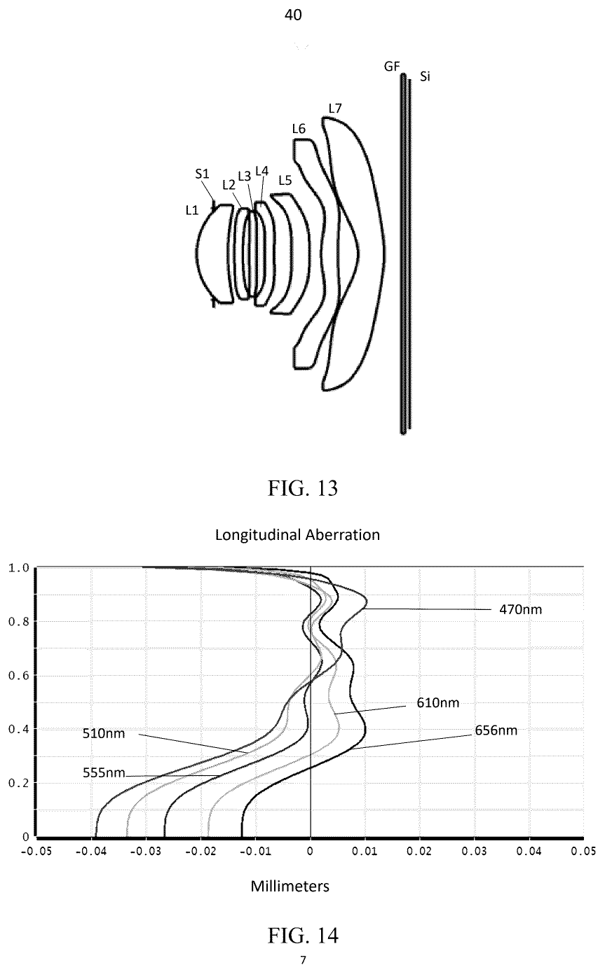

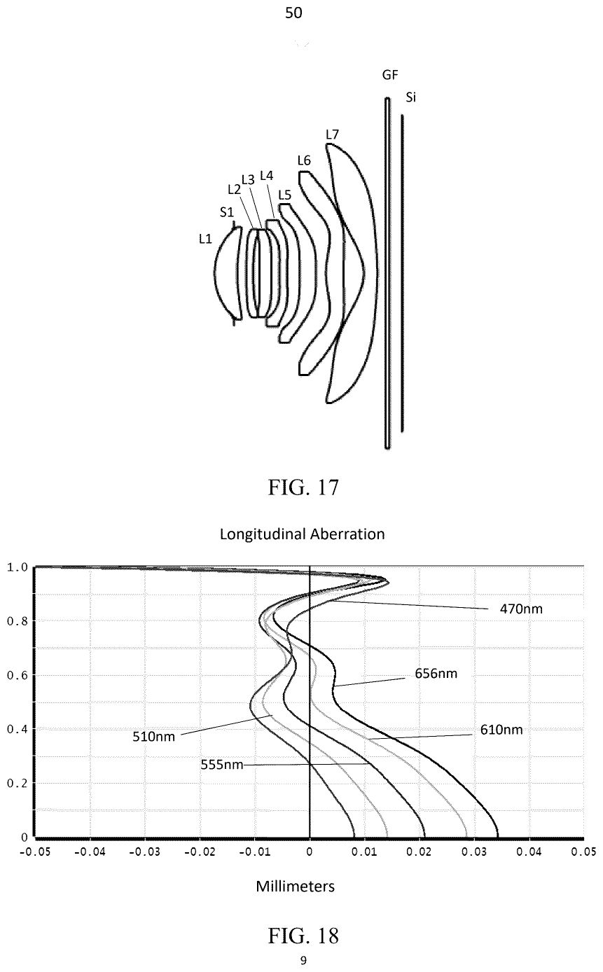

Referring to the drawings, the technical solutions of the present disclosure provide camera optical lenses 10, 20, 30, 40 and 50. FIG. 1, FIG. 5, FIG. 9, FIG. 13, and FIG. 17 show camera optical lenses 10, 20, 30, 40 and 50, and the camera optical lenses 10, 20, 30, 40 and 50 include seven lenses. Specifically, the camera optical lens 10 sequentially includes from an object side to an image side: an aperture S1, a first lens L1, a second lens L2, a third lens L3, a fourth lens L4, a fifth lens L5, a sixth lens L6 and a seventh lens L7. An optical element such as a optical filter may be provided between the seventh lens L7 and an image surface Si.

The first lens L1 is made of plastic material, the second lens L2 is made of plastic material or glass, the third lens L3 is made of plastic material, the fourth lens L4 is made of plastic material, the fifth lens L5 is made of plastic material, the sixth lens L6 is made of plastic material, and the seventh lens L7 is made of plastic material. The lenses may also be made of other materials.

It is defined that a focal length of the camera optical lens 10 is f, a focal length of the sixth lens L6 is f6, a focal length of the seventh lens L7 is f7, and a following relational expression is satisfied: 1.40≤(f6−f7)/f≤1.70. By reasonably distributing the refractive power of the optical system, it is beneficial to correcting the astigmatism and distortion of the camera optical lens 10, |Distortion|≤4%, thereby reducing the possibility of vignetting generation.

It is defined that a central curvature radius of the object-side surface of the seventh lens L7 is R13, and a central curvature radius of the image-side surface of the seventh lens L7 is R14, and a following relational expression is satisfied: 2.00≤R14/R13≤6.00, which specifies a shape of the seventh lens L7. Within the range of the relational expression, the degree of the deflection of light passing through the lens may be reduced, thereby effectively correcting the chromatic aberration, |LC|<3.0 μm.

It is defined that an Abbe number of the first lens L1 is v1, and a following relational expression is satisfied: 60.00≤v1≤82.00, which specifies the Abbe number of the first lens L1. Within the above range, material properties may be effectively distributed, thereby effectively correcting the chromatic aberration, |LC|≤3.0 μm.

It is defined that a central curvature radius of an object-side surface of the second lens L2 is R3, a central curvature radius of an image-side surface of the second lens L2 is R4, and a following relational expression is satisfied: 2.30≤(R3+R4)/(R3−R4)≤10.00, which specifies a shape of the second lens L2. Within the relational expression, the degree of deviation of light passing through the lens may be reduced, and the aberration is effectively corrected.

It is defined that an on-axis thickness of the third lens is d5, an on-axis thickness of the fourth lens is d7, and a following relational expression is satisfied: 0.80≤d5/d7≤2.00, which specifies a ratio of an on-axis thickness of the third lens L3 to an on-axis thickness of the fourth lens L4, and it helps to compress the total length of the optical system within the range of the relational expression.

When the above relational expressions are satisfied, the camera optical lenses 10, 20, 30, 40 and 50 have good optical performance and may satisfy the design requirements of large aperture, wide-angle and ultra-thinness. According to the characteristics of the camera optical lenses 10, 20, 30, 40 and 50, the camera optical lenses 10, 20, 30, 40 and 50 are particularly suitable for mobile phone camera lens assembly and the WEB camera lens composed of camera elements such as CCD and CMOS for high pixels.

Based on the above relational expressions and the achievable functions, the characteristics of each lens are further defined as follows.

An object-side surface of the first lens L1 is convex in a paraxial region, an image-side surface of the first lens L1 is concave in the paraxial region, and the first lens L1 has positive refractive power. The object-side surface and the image-side surface of the first lens L1 may also be provided with other concave and convex distributions.

A focal length of the first lens L1 is f1, and a following relational expression is satisfied: 0.69≤f1/f≤1.03. By reasonably distributing refractive powers, the system has better imaging quality and lower sensitivity.

It is defined that a central curvature radius of the object-side surface of the first lens L1 is R1, a central curvature radius of the image-side surface of the first lens L1 is R2, and a following relational expression is satisfied: −2.66≤(R1+R2)/(R1−R2)≤−1.84. By reasonably controlling a shape of the first lens L1, the first lens L1 may effectively correct the spheric aberration of the system.

An on-axis thickness of the first lens L1 is d1, a total optical length from the object-side surface of the first lens to an image plane of the camera optical lens along an optic axis of the camera optical lens 10 is TTL, and a following relational expression is satisfied: 0.07≤d1/TTL≤0.15. Within the range of the relational expression, it is beneficial to achieving ultra-thinness.

An object-side surface of the second lens L2 is convex in a paraxial region, an image-side surface of the second lens L2 is concave in the paraxial region, and the second lens L2 has negative refractive power. The object-side surface and the image-side surface of the second lens L2 may also be provided with other concave and convex distributions.

A focal length of the second lens L2 is f2, and a following relational expression is satisfied: −6.90≤f2/f≤−2.34. By reasonably distributing refractive powers, the system has better imaging quality and lower sensitivity.

An on-axis thickness of the second lens L2 is d3, the total optical length from the object-side surface of the first lens to an image plane of the camera optical lens along an optic axis of the camera optical lens 10 is TTL, and a following relational expression is satisfied: 0.03≤d3/TTL≤0.04. Within the range of the relational expression, it is beneficial to achieve ultra-thinness.

An object-side surface of the third lens L3 is convex in a paraxial region, an image-side surface of the third lens L3 is concave in the paraxial region, and the third lens L3 has positive or negative refractive power. The object-side surface and the image-side surface of the third lens L3 may also be provided with other concave and convex distributions.

A focal length of the third lens L3 is f3, and a following relational expression is satisfied: −6.08≤f3/f≤13.84. By reasonably distributing refractive power, the system has better imaging quality and lower sensitivity.

A central curvature radius of the object-side surface of the third lens L3 is R5, and a central curvature radius of the image-side surface of the third lens L3 is R6, and a following relational expression is satisfied: −5.96≤(R5+R6)/(R5−R6)≤−0.74, which specifies a shape of the third lens L3, which is beneficial to the molding of the third lens L3. Within the specified range of the conditional expression, the deflection degree of light passing through the lens can be mitigated, thereby effectively reducing aberration.

An on-axis thickness of the third lens L3 is d5, the total optical length from the object-side surface of the first lens to an image plane of the camera optical lens along an optic axis of the camera optical lens 10 is TTL, and a following relational expression is satisfied: 0.03≤d5/TTL≤0.08. Within the range of the relational expression, it is beneficial to achieve ultra-thinness.

An object-side surface of the fourth lens L4 is convex in a paraxial region, an image-side surface of the fourth lens L4 is concave in the paraxial region, and the fourth lens L4 has negative refractive power. The object-side surface and the image-side surface of the fourth lens L4 may also be provided with other concave and convex distributions.

A focal length of the fourth lens L4 is f4, and a following relational expression is satisfied: −5.46≤f4/f≤−2.12. By reasonably distributing refractive powers, the system has better imaging quality and lower sensitivity.

A central curvature radius of the object-side surface of the fourth lens L4 is R7, a central curvature radius of the image-side surface of the fourth lens L4 is R8, and a following relational expression is satisfied: 0.81≤(R7+R8)/(R7−R8)<3.77, which specifies a shape of the fourth lens L4. Within the above range, as lenses develop towards ultra-thinness and wide-angle, it is beneficial to correct the problem of off-axis aberration.

An on-axis thickness of the fourth lens L4 is d7, and a total optical length from the object-side surface of the first lens to an image plane of the camera optical lens along an optic axis of the camera optical lens is TTL, and a following relational expression is satisfied: 0.02≤d7/TTL≤0.05. Within the range of the relational expression, it is beneficial to achieve ultra-thinness.

An object-side surface of the fifth lens L5 is concave in a paraxial region, an image-side surface of the fifth lens L5 is convex in the paraxial region, and the fifth lens L5 has positive or negative refractive power. The object-side surface and the image-side surface of the fifth lens L5 may also be provided with other concave and convex distributions.

A focal length of the fifth lens L5 is f5, and a following relational expression is satisfied: −57.40≤f5/f≤112.29, and the limitation on the fifth lens L5 may effectively make the light angle of the camera optical lens 10 gentle and reduce the tolerance sensitivity.

A central curvature radius of the object-side surface of the fifth lens L5 is R9, a central curvature radius of the image-side surface of the fifth lens L5 is R10, and a following relational expression is satisfied: −3.61≤(R9+R10)/(R9−R10)≤1.85, which specifies a shape of the fifth lens L5. Within the above range, as lenses develop towards ultra-thinness and wide-angle, it is beneficial to correct the problem of off-axis aberration.

An on-axis thickness of the fifth lens L5 is d9, and a following relational expression is satisfied: 0.06≤d9/TTL≤0.09. Within the range of the relational expression, it is beneficial to achieve ultra-thinness.

An object-side surface of the sixth lens L6 is convex in a paraxial region, an image-side surface of the sixth lens L6 is concave in the paraxial region, and the sixth lens L6 has positive refractive power. The object-side surface and the image-side surface of the sixth lens L6 may also be provided with other concave and convex distributions.

A focal length of the sixth lens L6 is f6, and a following relational expression is satisfied: 0.68≤f6/f≤0.95. By reasonably distributing refractive powers, the system has better imaging quality and lower sensitivity.

A central curvature radius of an object-side surface of the sixth lens L6 is R11, a central curvature radius of an image-side surface of the sixth lens L6 is R12, and a following relational expression is satisfied: −1.41≤(R11+R12)/≤−1.01, which specifies a shape of the sixth lens L6. Within the above range, with the development of ultra-thinness and wide-angle lenses, it is beneficial to correcting the off-axis aberration.

An on-axis thickness of the sixth lens L6 is d11, and a following relational expression is satisfied: 0.01≤d11/TTL≤0.62. Within the range of the relational expression, it is beneficial to achieve ultra-thinness.

An object-side surface of the seventh lens L7 is concave in a paraxial region, an image-side surface of the seventh lens L7 is convex in the paraxial region, and the seventh lens L7 has negative refractive power. The object-side surface and the image-side surface of the seventh lens L7 may also be provided with other concave and convex distributions.

A focal length of the seventh lens L7 is f7, and a following relational expression is satisfied: −0.90≤f7/f≤−0.55. By reasonably distributing refractive powers, the system has better imaging quality and lower sensitivity.

A central curvature radius of the object-side surface of the seventh lens L7 is R13, a central curvature radius of the image-side surface of the seventh lens L7 is R14, and a following relational expression is satisfied: −2.97≤(R13+R14)/≤−1.50, which specifies a shape of the seventh lens L7. Within the range of the relational expression, as lenses develop towards ultra-thinness and wide-angle, it is beneficial to correcting the problem of off-axis aberration.

An on-axis thickness of the seventh lens L7 is d13, and a following relational expression is satisfied: 0.07≤d13/TTL≤0.14. Within the range of the relational expression, it is beneficial to achieve ultra-thinness.

A field of view FOV at 1.0 field of view of the camera optical lens 10 is greater than or equal to 64.15°, thereby achieving wide-angle.

An F-number FNO of the camera optical lens 10 is smaller than or equal to 2.850, thereby achieving a large aperture and good imaging performance of the camera optical lens.

The camera optical lens of the present disclosure will be described below with examples. The reference signs recited in each Example are shown below. The units of the focal length, the on-axis distance, the central curvature radius, the on-axis thickness, the inflection point position, and the arrest point position are mm.

TTL: an optical length (an on-axis distance from an object-side surface of the first lens L1 to the image plane Si) in mm;
F-number FNO: a ratio of the effective focal length of the camera optical lens to the entrance pupil diameter.

Image height IH at 1.0 field of view: a field of view height corresponding to the sensor effective pixel (that is, half of a diagonal length of the sensor effective pixel area);
Field of view FOV at 1.0 field of view: a field of view corresponding to the active pixel of the sensor;
Image height IHm at MIC (Microscope Infrared Spectroscopy) field of view: a height of the field of view expanding beyond 1.0 field of view for preventing assembly deviation.

Field of view FOVm at MIC field of view: a field of view corresponding to an image height at MIC field of view.

Optionally, the object-side surface and/or the image-side surface of the lens may be further provided with an inflection point and/or an arrest point, so as to meet high-quality imaging requirements.

The technical solutions of the present disclosure will be specifically described in five Examples. Meanwhile, a Comparative Example is provided as a reference, and the technical effects of the present disclosure cannot be achieved when the ranges of the above relational expressions are exceeded.

### Example 1

Table 1 shows design data of the camera optical lens 10 according to Example 1 of the present disclosure.

TABLE 1

| | R | d | | nd | | νd | |
|---|---|---|---|---|---|---|---|
| S1 | ∞ | d0 = | −0.554 | | | | |
| R1 | 1.806 | d1 = | 0.720 | nd1 | 1.4959 | ν1 | 81.64 |
| R2 | 5.052 | d2 = | 0.252 | | | | |
| R3 | 9.973 | d3 = | 0.230 | nd2 | 1.6700 | ν2 | 19.39 |
| R4 | 6.973 | d4 = | 0.212 | | | | |
| R5 | 21.468 | d5 = | 0.307 | nd3 | 1.5444 | ν3 | 55.82 |
| R6 | 162.798 | d6 = | 0.197 | | | | |
| R7 | 12.635 | d7 = | 0.240 | nd4 | 1.6700 | ν4 | 19.39 |
| R8 | 7.100 | d8 = | 0.413 | | | | |
| R9 | −85.406 | d9 = | 0.406 | nd5 | 1.5661 | ν5 | 37.71 |
| R10 | −174.594 | d10 = | 0.325 | | | | |
| R11 | 2.278 | d11 = | 0.585 | nd6 | 1.5444 | ν6 | 55.82 |
| R12 | 19.423 | d12 = | 0.686 | | | | |
| R13 | −1.235 | d13 = | 0.457 | nd7 | 1.5444 | ν7 | 55.82 |
| R14 | −4.206 | d14 = | 0.248 | | | | |
| R15 | ∞ | d15 = | 0.110 | ndg | 1.5168 | νg | 64.17 |
| R16 | ∞ | d16 = | 0.462 | | | | |

S1: aperture;
R: central curvature radius of the optical surface;
R1: central curvature radius of the object-side surface of the first lens L1;
R2: central curvature radius of the image-side surface of the first lens L1;
R3: central curvature radius of the object-side surface of the second lens L2;
R4: central curvature radius of the image-side surface of the second lens L2;
R5: central curvature radius of the object-side surface of the third lens L3;
R6: central curvature radius of the image-side surface of the third lens L3;
R7: central curvature radius of the object-side surface of the fourth lens L4;
R8: central curvature radius of the image-side surface of the fourth lens L4;
R9: central curvature radius of the object-side surface of the fifth lens L5;
R10: central curvature radius of the image-side surface of the fifth lens L5;
R11: central curvature radius of the object-side surface of the sixth lens L6;
R12: central curvature radius of the image-side surface of the sixth lens L6;
R13: central curvature radius of the object-side surface of the seventh lens L7;
R14: central curvature radius of the image-side surface of the seventh lens L7;
R15: curvature radius of the object-side surface of the optical filter GF;
R16: curvature radius of the image-side surface of the optical filter GF;
d: on-axis thickness of lenses and an on-axis distance between lenses;
d0: on-axis distance from the aperture S1 to the object-side surface of the first lens L1;
d1: on-axis thickness of the first lens L1;
d2: on-axis distance from the image-side surface of the first lens LI to the object-side surface of the second lens L2;
d3: on-axis thickness of the second lens L2;
d4: on-axis distance from the image-side surface of the second lens L2 to the object-side surface of the third lens L3;
d5: on-axis thickness of the third lens L3;
d6: on-axis distance from the image-side surface of the third lens L3 to the object-side surface of the fourth lens L4;
d7: on-axis thickness of the fourth lens L4;
d8: on-axis distance from the image-side surface of the fourth lens L4 to the object-side surface of the fifth lens L5;
d9: on-axis thickness of the fifth lens L5;
d10: on-axis distance from the image-side surface of the fifth lens L5 to the object-side surface of the sixth lens L6;
d11: on-axis thickness of the sixth lens L6;
d12: on-axis distance from the image-side surface of the sixth lens L6 to the object-side surface of the seventh lens L7;
d13: on-axis thickness of the seventh lens L7;
d14: on-axis distance from the image-side surface of the seventh lens L7 to the object-side surface of the eighth lens L8;
d15: on-axis thickness of the optical filter GF;
d16: on-axis distance from the image-side surface of the optical filter GF to the image surface;
nd: refractive index of d line;
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
nd6: refractive index of d line of the sixth lens L6;
nd7: refractive index of d line of the seventh lens L7;
ndg: refractive index of d line of the optical filter GF;
vd: Abbe number;
v1: Abbe number of the first lens L1;
v2: Abbe number of the second lens L2;
v3: Abbe number of the third lens L3;
v4: Abbe number of the fourth lens L4;
v5: Abbe number of the fifth lens L5;
v6: Abbe number of the sixth lens L6;
v7: Abbe number of the seventh lens L7; and
vg: Abbe number of the optical filter GF.

Table 2 and Table 3 show the aspheric surface data of the lenses in the camera optical lens 10 according to Example 1 of the present disclosure.

TABLE 2

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −2.9855E−01 | 1.5464E−02 | −4.4231E−02 | 1.3810E−01 | −2.4636E−01 | 2.7382E−01 | −1.9067E−01 |
| R2 | −1.6127E+01 | 2.2507E−02 | −1.0601E−01 | 3.5215E−01 | −7.4085E−01 | 9.6846E−01 | −7.9473E−01 |
| R3 | 1.2125E+01 | −3.5289E−02 | 6.7575E−02 | −1.7780E−01 | 3.7287E−01 | −4.7683E−01 | 3.8961E−01 |
| R4 | 2.1753E+01 | −3.4809E−02 | 8.8284E−02 | −2.8752E−01 | 6.9893E−01 | −1.0047E+00 | 8.6330E−01 |
| R5 | 3.2904E+01 | −2.0781E−02 | −1.9149E−02 | 8.6733E−02 | −4.2377E−01 | 1.0573E+00 | −1.5535E+00 |
| R6 | −9.9990E+01 | −2.7899E−02 | −2.1516E−02 | 7.0021E−02 | −1.1227E−01 | 1.2509E−02 | 1.3546E−01 |
| R7 | −2.0813E+01 | −1.1505E−01 | −8.2207E−02 | 4.8192E−01 | −1.1803E+00 | 1.6394E+00 | −1.3584E+00 |
| R8 | −1.2638E+01 | −9.4739E−02 | −7.9883E−02 | 3.7999E−01 | −7.6373E−01 | 8.8870E−01 | −6.3207E−01 |
| R9 | 9.9000E+01 | −9.4361E−02 | 6.4732E−02 | −4.7415E−02 | 2.1074E−02 | −1.0237E−02 | 8.1071E−03 |
| R10 | 9.9900E+01 | −1.9162E−01 | 9.0565E−02 | −3.4144E−04 | −4.6837E−02 | 4.1814E−02 | −1.8083E−02 |
| R11 | −1.0018E+00 | −9.5458E−02 | −6.3015E−03 | 2.1266E−02 | −2.4117E−02 | 1.5372E−02 | −6.1477E−03 |
| R12 | 4.7707E+00 | 5.7494E−02 | −7.7007E−02 | 4.1530E−02 | −1.7113E−02 | 5.5585E−03 | −1.3375E−03 |
| R13 | −1.0000E+00 | 1.3476E−01 | −8.7094E−02 | 5.4236E−02 | −2.3296E−02 | 6.9747E−03 | −1.5084E−03 |
| R14 | −2.5538E−02 | 6.4876E−02 | −4.3935E−02 | 2.2637E−02 | −8.4533E−03 | 2.3026E−03 | −4.6051E−04 |

TABLE 3

| | Aspheric Coefficient | | | | | | | |
|---|---|---|---|---|---|---|---|---|
| | A16 | A18 | A20 | A22 | A24 | A26 | A28 | A30 |
| R1 | 8.0393E−02 | −1.8701E−02 | 1.8059E−03 | 0.0000E+00 | 0.0000E+00 | 0.0000E+00 | 0.0000E+00 | 0.0000E+00 |
| R2 | 3.9738E−01 | −1.1052E−01 | 1.3071E−02 | 0.0000E+00 | 0.0000E+00 | 0.0000E+00 | 0.0000E+00 | 0.0000E+00 |
| R3 | −1.9769E−01 | 5.7626E−02 | −7.4477E−03 | 0.0000E+00 | 0.0000E+00 | 0.0000E+00 | 0.0000E+00 | 0.0000E+00 |
| R4 | −4.0608E−01 | 8.0449E−02 | 8.1484E−04 | 0.0000E+00 | 0.0000E+00 | 0.0000E+00 | 0.0000E+00 | 0.0000E+00 |
| R5 | 1.3330E+00 | −6.1976E−01 | 1.2140E−01 | 0.0000E+00 | 0.0000E+00 | 0.0000E+00 | 0.0000E+00 | 0.0000E+00 |
| R6 | −1.6349E−01 | 7.9848E−02 | −1.4153E−02 | 0.0000E+00 | 0.0000E+00 | 0.0000E+00 | 0.0000E+00 | 0.0000E+00 |
| R7 | 6.3964E−01 | −1.5017E−01 | 1.2453E−02 | 0.0000E+00 | 0.0000E+00 | 0.0000E+00 | 0.0000E+00 | 0.0000E+00 |
| R8 | 2.6786E−01 | −6.1451E−02 | 5.8394E−03 | 0.0000E+00 | 0.0000E+00 | 0.0000E+00 | 0.0000E+00 | 0.0000E+00 |
| R9 | −4.7934E−03 | 1.3644E−03 | −1.4176E−04 | 0.0000E+00 | 0.0000E+00 | 0.0000E+00 | 0.0000E+00 | 0.0000E+00 |
| R10 | 4.3029E−03 | −5.4193E−04 | 2.8354E−05 | 0.0000E+00 | 0.0000E+00 | 0.0000E+00 | 0.0000E+00 | 0.0000E+00 |
| R11 | 1.7079E−03 | −3.4674E−04 | 5.2120E−05 | −5.7293E−06 | 4.4579E−07 | −2.3149E−08 | 7.1663E−10 | −9.9663E−12 |
| R12 | 2.3081E−04 | −2.8163E−05 | 2.3803E−06 | −1.3317E−07 | 4.4955E−09 | −7.5570E−11 | 4.9786E−13 | −9.4365E−15 |
| R13 | 2.4105E−04 | −2.8743E−05 | 2.5527E−06 | −1.6651E−07 | 7.7431E−09 | −2.4277E−10 | 4.5954E−12 | −3.9633E−14 |
| R14 | 6.7590E−05 | −7.2503E−06 | 5.6385E−07 | −3.1300E−08 | 1.2045E−09 | −3.0423E−11 | 4.5184E−13 | −2.9762E−15 |

For convenience, the aspheric surface of each lens surface uses the aspheric surface shown in following formula (1). However, the present disclosure is not limited to the aspheric polynomial form shown in formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} , \qquad ( 1 )$$

k is a conic coefficient, A4, A6, A8, A10, A12, A14, A16, A18, A20, A22, A24, A26, A28 and A30 are aspheric coefficients, c is a curvature at a center of an optical surface, r is a vertical distance between a point on an aspheric curve and an optic axis, and z is an aspheric depth (a vertical distance between a point on the aspherical surface having a distance r from the optical axis, and a tangent plane tangent to a vertex on the aspherical optical axis).

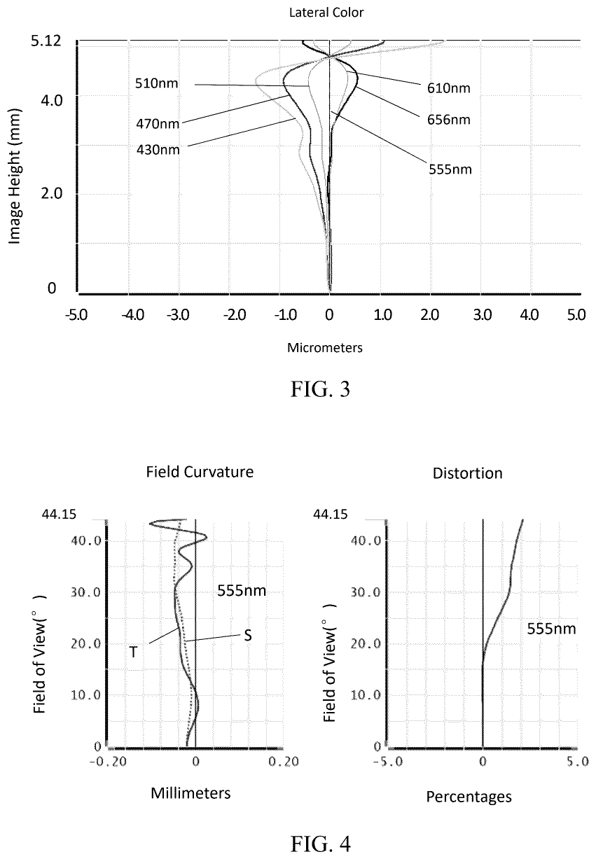

FIG. 2 and FIG. 3 respectively show longitudinal aberration and lateral color of light with wavelengths of 656 nm, 610 nm, 555 nm, 510 nm, 470 nm, and 430 nm after passing through the camera optical lens 10 according to Example 1. FIG. 4 shows field curvature and distortion of light with a wavelength of 555 nm after passing through the camera optical lens 10 according to Example 1, the field curvature S in FIG. 4 is a field curvature in a sagittal direction, and Tis a field curvature in a meridian direction.

In this Example, the entrance pupil diameter ENPD of the camera optical lens 10 is 2.714 mm, the image height IH at 1.0 field of view is 5.120 mm, the field of view FOV at the 1.0 field of view is 88.30°, the image height IHm at MIC field of view is 5.335 mm, and the field of view FOVm at MIC field of view is 90.69°. The camera optical lens 10 meets the design requirements of large aperture, wide-angle and ultra-thinness, effectively correcting both the on-axis and off-axis chromatic aberrations thereof, and has excellent optical characteristics.

### Example 2

The meaning of the reference signs of Example 2 is the same as that of Example 1.

FIG. 5 shows a camera optical lens 20 according to Example 2 of the present disclosure.

Table 4 shows design data of a camera optical lens 20 according to Example 2 of the present disclosure.

TABLE 4

| | R | d | | nd | | νd | |
|---|---|---|---|---|---|---|---|
| S1 | ∞ | d0 = | −0.577 | | | | |
| R1 | 1.887 | d1 = | 1.004 | nd1 | 1.4959 | ν1 | 81.64 |
| R2 | 6.342 | d2 = | 0.288 | | | | |
| R3 | 15.353 | d3 = | 0.226 | nd2 | 1.6700 | ν2 | 19.39 |
| R4 | 6.069 | d4 = | 0.195 | | | | |
| R5 | 20.201 | d5 = | 0.393 | nd3 | 1.5444 | ν3 | 55.82 |
| R6 | 86.656 | d6 = | 0.257 | | | | |
| R7 | 15.961 | d7 = | 0.197 | nd4 | 1.6700 | ν4 | 19.39 |
| R8 | 9.256 | d8 = | 0.530 | | | | |
| R9 | −33.242 | d9 = | 0.533 | nd5 | 1.5661 | ν5 | 37.71 |
| R10 | −330.132 | d10 = | 0.364 | | | | |
| R11 | 2.559 | d11 = | 0.517 | nd6 | 1.5444 | ν6 | 55.82 |
| R12 | 41.055 | d12 = | 0.581 | | | | |
| R13 | −1.289 | d13 = | 0.775 | nd7 | 1.5444 | ν7 | 55.82 |
| R14 | −3.767 | d14 = | 0.289 | | | | |
| R15 | ∞ | d15 = | 0.110 | ndg | 1.5168 | νg | 64.17 |
| R16 | ∞ | d16 = | 0.550 | | | | |

Table 5 and Table 6 show aspheric surface data of each lens in the camera optical lens 20 according to Example 2 of the present disclosure.

TABLE 5

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −2.6002E−01 | 1.4820E−02 | −4.3838E−02 | 1.3837E−01 | −2.4658E−01 | 2.7469E−01 | −1.9065E−01 |
| R2 | −2.5525E+01 | 2.7723E−02 | −9.5596E−02 | 3.5041E−01 | −7.4053E−01 | 9.7022E−01 | −7.9471E−01 |
| R3 | 7.7720E+01 | −2.4229E−02 | 6.1964E−02 | −1.7212E−01 | 3.6463E−01 | −4.7891E−01 | 3.9308E−01 |
| R4 | 2.0180E+01 | −3.9199E−02 | 9.6106E−02 | −3.1190E−01 | 7.0365E−01 | −9.9982E−01 | 8.6077E−01 |
| R5 | −1.8500E+02 | −2.1801E−02 | −2.8020E−02 | 9.7591E−02 | −4.2529E−01 | 1.0596E+00 | −1.5542E+00 |
| R6 | 4.0981E+03 | −2.3944E−02 | −2.1247E−02 | 6.8375E−02 | −1.0708E−01 | 1.2121E−02 | 1.3745E−01 |
| R7 | 3.3730E+01 | −1.0592E−01 | −9.2688E−02 | 4.8646E−01 | −1.1843E+00 | 1.6408E+00 | −1.3584E+00 |
| R8 | −5.6696E+01 | −9.5735E−02 | −8.1357E−02 | 3.7857E−01 | −7.6475E−01 | 8.8913E−01 | −6.3233E−01 |
| R9 | 3.3197E+02 | −1.0549E−01 | 6.2655E−02 | −4.6682E−02 | 2.1821E−02 | −1.0193E−02 | 8.0442E−03 |
| R10 | 2.4303E+04 | −1.8741E−01 | 8.7687E−02 | −6.8076E−04 | −4.6989E−02 | 4.1851E−02 | −1.8071E−02 |
| R11 | −9.2512E−01 | −9.5380E−02 | −5.7023E−03 | 2.1252E−02 | −2.4123E−02 | 1.5372E−02 | −6.1476E−03 |
| R12 | 8.2028E+01 | 5.7636E−02 | −7.7021E−02 | 4.1581E−02 | −1.7110E−02 | 5.5584E−03 | −1.3376E−03 |
| R13 | −1.0297E+00 | 1.3362E−01 | −8.7179E−02 | 5.4237E−02 | −2.3296E−02 | 6.9747E−03 | −1.5084E−03 |
| R14 | −4.5338E−02 | 6.5645E−02 | −4.4000E−02 | 2.2681E−02 | −8.4554E−03 | 2.3025E−03 | −4.6050E−04 |

TABLE 6

| | Aspheric Coefficient | | | | | | | |
|---|---|---|---|---|---|---|---|---|
| | A16 | A18 | A20 | A22 | A24 | A26 | A28 | A30 |
| R1 | 8.0312E−02 | −1.8787E−02 | 1.8818E−03 | 0.0000E+00 | 0.0000E+00 | 0.0000E+00 | 0.0000E+00 | 0.0000E+00 |
| R2 | 3.9671E−01 | −1.1029E−01 | 1.3155E−02 | 0.0000E+00 | 0.0000E+00 | 0.0000E+00 | 0.0000E+00 | 0.0000E+00 |
| R3 | −1.9739E−01 | 5.6485E−02 | −7.1176E−03 | 0.0000E+00 | 0.0000E+00 | 0.0000E+00 | 0.0000E+00 | 0.0000E+00 |
| R4 | −4.0908E−01 | 8.2385E−02 | 4.7361E−04 | 0.0000E+00 | 0.0000E+00 | 0.0000E+00 | 0.0000E+00 | 0.0000E+00 |
| R5 | 1.3321E+00 | −6.1685E−01 | 1.1957E−01 | 0.0000E+00 | 0.0000E+00 | 0.0000E+00 | 0.0000E+00 | 0.0000E+00 |
| R6 | −1.6250E−01 | 7.9294E−02 | −1.4845E−02 | 0.0000E+00 | 0.0000E+00 | 0.0000E+00 | 0.0000E+00 | 0.0000E+00 |
| R7 | 6.3957E−01 | −1.5001E−01 | 1.2280E−02 | 0.0000E+00 | 0.0000E+00 | 0.0000E+00 | 0.0000E+00 | 0.0000E+00 |
| R8 | 2.6779E−01 | −6.1390E−02 | 5.8560E−03 | 0.0000E+00 | 0.0000E+00 | 0.0000E+00 | 0.0000E+00 | 0.0000E+00 |
| R9 | −4.8090E−03 | 1.3705E−03 | −1.4202E−04 | 0.0000E+00 | 0.0000E+00 | 0.0000E+00 | 0.0000E+00 | 0.0000E+00 |
| R10 | 4.3049E−03 | −5.4269E−04 | 2.8332E−05 | 0.0000E+00 | 0.0000E+00 | 0.0000E+00 | 0.0000E+00 | 0.0000E+00 |
| R11 | 1.7079E−03 | −3.4674E−04 | 5.2120E−05 | −5.7293E−06 | 4.4579E−07 | −2.3149E−08 | 7.1664E−10 | −9.9652E−12 |
| R12 | 2.3081E−04 | −2.8163E−05 | 2.3803E−06 | −1.3317E−07 | 4.4952E−09 | −7.5587E−11 | 5.0339E−13 | −9.5642E−15 |
| R13 | 2.4105E−04 | −2.8743E−05 | 2.5527E−06 | −1.6651E−07 | 7.7431E−09 | −2.4277E−10 | 4.5954E−12 | −3.9632E−14 |
| R14 | 6.7590E−05 | −7.2503E−06 | 5.6385E−07 | −3.1300E−08 | 1.2045E−09 | −3.0423E−11 | 4.5181E−13 | −2.9746E−15 |

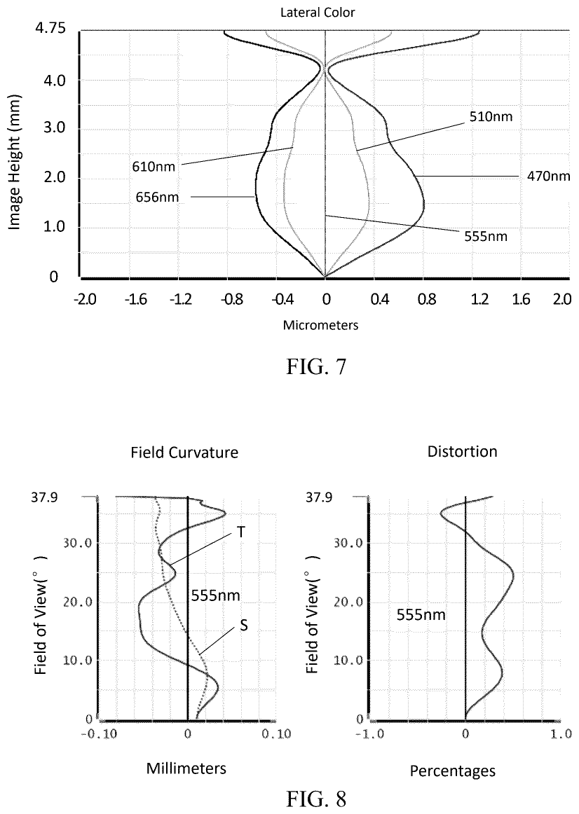

FIG. 6 and FIG. 7 show longitudinal aberration and lateral color of light with wavelengths of 656 nm, 610 nm, 555 nm, 510 nm and 470 nm after passing the camera optical lens 20 according to Example 2. FIG. 8 shows field curvature and distortion of light with a wavelength of 555 nm after passing through the camera optical lens 20 according to Example 2, the field curvature S in FIG. 8 is a field curvature in a sagittal direction, and T is a field curvature in a meridian direction.

In this Example, the entrance pupil diameter ENPD of the camera optical lens 20 is 2.714 mm, the image height IH at 1.0 field of view is 4.985 mm, the field of view FOV at the 1.0 field of view is 75.82°, the image height IHm at MIC field of view is 5.213 mm, and the field of view FOVm at MIC field of view is 78.13°. The camera optical lens 20 meets the design requirements of large aperture, wide-angle and ultra-thinness, effectively correcting both the on-axis and off-axis chromatic aberrations thereof, and has excellent optical characteristics.

### Example 3

The meaning of the reference signs of Example 3 is the same as that of Example 1.

It differs from Example 1 that: an object-side surface of the third lens L3 is concave in a paraxial region, an image-side surface of the fourth lens L4 is concave in the paraxial region, and the third lens L3 has a positive refractive power.

FIG. 9 shows a camera optical lens 30 according to Example 3 of the present disclosure.

Table 7 shows design data of the camera optical lens 30 according to Example 3 of the present disclosure.

TABLE 7

| | R | d | | nd | | νd | |
|---|---|---|---|---|---|---|---|
| S1 | ∞ | d0 = | −0.530 | | | | |
| R1 | 1.894 | d1 = | 0.624 | nd1 | 1.5806 | ν1 | 60.07 |
| R2 | 4.181 | d2 = | 0.158 | | | | |
| R3 | 6.984 | d3 = | 0.283 | nd2 | 1.6700 | ν2 | 19.39 |
| R4 | 5.713 | d4 = | 0.280 | | | | |
| R5 | −29.522 | d5 = | 0.575 | nd3 | 1.5444 | ν3 | 55.82 |
| R6 | 199.195 | d6 = | 0.411 | | | | |
| R7 | −117.993 | d7 = | 0.291 | nd4 | 1.6700 | ν4 | 19.39 |
| R8 | 12.297 | d8 = | 0.930 | | | | |
| R9 | −27.726 | d9 = | 0.639 | nd5 | 1.5661 | ν5 | 37.71 |
| R10 | −51.220 | d10 = | 0.513 | | | | |
| R11 | 2.657 | d11 = | 0.497 | nd6 | 1.5444 | ν6 | 55.82 |
| R12 | 28.948 | d12 = | 0.543 | | | | |
| R13 | −1.375 | d13 = | 1.101 | nd7 | 1.5444 | ν7 | 55.82 |
| R14 | −2.776 | d14 = | 0.493 | | | | |
| R15 | ∞ | d15 = | 0.110 | ndg | 1.5168 | νg | 64.17 |
| R16 | ∞ | d16 = | 0.655 | | | | |

Table 8 and Table 9 show aspheric surface data of each lens in the camera optical lens 30 according to Example 3 of the present disclosure.

TABLE 8

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −3.6290E−01 | 1.6232E−02 | −4.2278E−02 | 1.3723E−01 | −2.4581E−01 | 2.7358E−01 | −1.9061E−01 |
| R2 | −2.0013E+01 | 1.8189E−02 | −1.0779E−01 | 3.5393E−01 | −7.3979E−01 | 9.6940E−01 | −7.9503E−01 |
| R3 | 2.3542E+00 | −4.1908E−02 | 7.0251E−02 | −1.7650E−01 | 3.7198E−01 | −4.7552E−01 | 3.8865E−01 |
| R4 | 2.2367E+01 | −2.3698E−02 | 8.6972E−02 | −2.8966E−01 | 6.9488E−01 | −1.0046E+00 | 8.6283E−01 |
| R5 | −2.4761E+03 | −1.2735E−02 | −1.3013E−02 | 8.5088E−02 | −4.1718E−01 | 1.0544E+00 | −1.5539E+00 |
| R6 | 1.2043E+04 | −1.6429E−02 | −1.6742E−02 | 6.8283E−02 | −1.0967E−01 | 1.4908E−02 | 1.3604E−01 |
| R7 | 8.4599E+03 | −1.2115E−01 | −8.6380E−02 | 4.8128E−01 | −1.1818E+00 | 1.6394E+00 | −1.3580E+00 |
| R8 | −2.3940E+02 | −9.3097E−02 | −7.8222E−02 | 3.7950E−01 | −7.6412E−01 | 8.8889E−01 | −6.3202E−01 |
| R9 | 2.2656E+02 | −1.0804E−01 | 6.5759E−02 | −4.5361E−02 | 2.1532E−02 | −1.0192E−02 | 8.1280E−03 |
| R10 | 4.2974E+02 | −1.8005E−01 | 8.6027E−02 | −9.4092E−04 | −4.6864E−02 | 4.1839E−02 | −1.8078E−02 |
| R11 | −6.9274E−01 | −9.2011E−02 | −6.1954E−03 | 2.1273E−02 | −2.4122E−02 | 1.5372E−02 | −6.1477E−03 |
| R12 | 8.2070E+01 | 5.6773E−02 | −7.6886E−02 | 4.1652E−02 | −1.7114E−02 | 5.5580E−03 | −1.3376E−03 |
| R13 | −9.8564E−01 | 1.3441E−01 | −8.7089E−02 | 5.4233E−02 | −2.3296E−02 | 6.9747E−03 | −1.5084E−03 |
| R14 | −4.8478E−01 | 7.0305E−02 | −4.3863E−02 | 2.2633E−02 | −8.4534E−03 | 2.3025E−03 | −4.6050E−04 |

TABLE 9

| | Aspheric Coefficient | | | | | | | |
|---|---|---|---|---|---|---|---|---|
| | A16 | A18 | A20 | A22 | A24 | A26 | A28 | A30 |
| R1 | 8.0444E−02 | −1.8789E−02 | 1.8403E−03 | 0.0000E+00 | 0.0000E+00 | 0.0000E+00 | 0.0000E+00 | 0.0000E+00 |
| R2 | 3.9728E−01 | −1.1046E−01 | 1.3055E−02 | 0.0000E+00 | 0.0000E+00 | 0.0000E+00 | 0.0000E+00 | 0.0000E+00 |
| R3 | −1.9772E−01 | 5.7754E−02 | −7.4052E−03 | 0.0000E+00 | 0.0000E+00 | 0.0000E+00 | 0.0000E+00 | 0.0000E+00 |
| R4 | −4.0732E−01 | 8.1133E−02 | 6.8503E−04 | 0.0000E+00 | 0.0000E+00 | 0.0000E+00 | 0.0000E+00 | 0.0000E+00 |
| R5 | 1.3318E+00 | −6.1777E−01 | 1.2127E−01 | 0.0000E+00 | 0.0000E+00 | 0.0000E+00 | 0.0000E+00 | 0.0000E+00 |
| R6 | −1.6294E−01 | 8.0278E−02 | −1.4660E−02 | 0.0000E+00 | 0.0000E+00 | 0.0000E+00 | 0.0000E+00 | 0.0000E+00 |
| R7 | 6.3968E−01 | −1.4960E−01 | 1.2409E−02 | 0.0000E+00 | 0.0000E+00 | 0.0000E+00 | 0.0000E+00 | 0.0000E+00 |
| R8 | 2.6781E−01 | −6.1500E−02 | 5.8490E−03 | 0.0000E+00 | 0.0000E+00 | 0.0000E+00 | 0.0000E+00 | 0.0000E+00 |
| R9 | −4.7932E−03 | 1.3545E−03 | −1.4528E−04 | 0.0000E+00 | 0.0000E+00 | 0.0000E+00 | 0.0000E+00 | 0.0000E+00 |
| R10 | 4.3037E−03 | −5.4189E−04 | 2.8254E−05 | 0.0000E+00 | 0.0000E+00 | 0.0000E+00 | 0.0000E+00 | 0.0000E+00 |
| R11 | 1.7079E−03 | −3.4674E−04 | 5.2120E−05 | −5.7293E−06 | 4.4579E−07 | −2.3149E−08 | 7.1665E−10 | −9.9631E−12 |
| R12 | 2.3080E−04 | −2.8163E−05 | 2.3803E−06 | −1.3317E−07 | 4.4954E−09 | −7.5563E−11 | 4.9841E−13 | −9.3498E−15 |
| R13 | 2.4105E−04 | −2.8743E−05 | 2.5527E−06 | −1.6651E−07 | 7.7431E−09 | −2.4277E−10 | 4.5954E−12 | −3.9636E−14 |
| R14 | 6.7590E−05 | −7.2503E−06 | 5.6385E−07 | −3.1300E−08 | 1.2045E−09 | −3.0423E−11 | 4.5183E−13 | −2.9757E−15 |

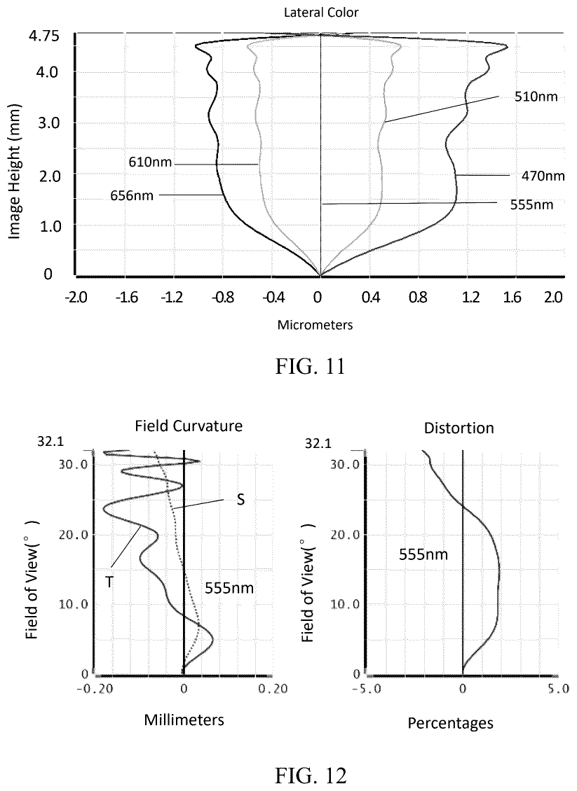

FIG. 10 and FIG. 11 show longitudinal aberration and lateral color of light with wavelengths of 656 nm, 610 nm, 555 nm, 510 nm and 470 nm after passing the camera optical lens 30 according to Example 3. FIG. 12 shows field curvature and distortion of light with a wavelength of 555 nm after passing through the camera optical lens 30 according to Example 3, the field curvature S in FIG. 12 is a field curvature in a sagittal direction, and T is a field curvature in a meridian direction.

In this Example, the entrance pupil diameter ENPD of the camera optical lens 30 is 2.714 mm, the image height IH at 1.0 field of view is 4.750 mm, the field of view FOV at the 1.0 field of view is 64.15°, the image height IHm at MIC field of view is 4.900 mm, and the field of view FOVm at MIC field of view is 66.04°. The camera optical lens 30 meets the design requirements of large aperture, wide-angle and ultra-thinness, effectively correcting both the on-axis and off-axis chromatic aberrations thereof, and has excellent optical characteristics.

### Example 4

The meaning of the reference signs of Example 4 is the same as that of Example 1.

FIG. 13 shows a camera optical lens 40 according to Example 4 of the present disclosure.

Table 10 shows design data of the camera optical lens 40 according to Example 4 of the present disclosure.

TABLE 10

| | R | d | | nd | | νd | |
|---|---|---|---|---|---|---|---|
| S1 | ∞ | d0 = | −0.522 | | | | |
| R1 | 1.823 | d1 = | 0.947 | nd1 | 1.4959 | ν1 | 81.64 |
| R2 | 5.310 | d2 = | 0.196 | | | | |
| R3 | 10.330 | d3 = | 0.256 | nd2 | 1.6700 | ν2 | 19.39 |
| R4 | 6.568 | d4 = | 0.192 | | | | |
| R5 | 13.117 | d5 = | 0.228 | nd3 | 1.5444 | ν3 | 55.82 |
| R6 | 18.414 | d6 = | 0.248 | | | | |
| R7 | 17.814 | d7 = | 0.284 | nd4 | 1.6700 | ν4 | 19.39 |
| R8 | 9.762 | d8 = | 0.531 | | | | |
| R9 | −28.584 | d9 = | 0.536 | nd5 | 1.5661 | ν5 | 37.71 |
| R10 | −50.525 | d10 = | 0.358 | | | | |
| R11 | 2.597 | d11 = | 0.511 | nd6 | 1.5444 | ν6 | 55.82 |
| R12 | 15.570 | d12 = | 0.611 | | | | |
| R13 | −1.291 | d13 = | 0.791 | nd7 | 1.5444 | ν7 | 55.82 |
| R14 | −3.466 | d14 = | 0.525 | | | | |
| R15 | ∞ | d15 = | 0.110 | ndg | 1.5168 | νg | 64.17 |
| R16 | ∞ | d16 = | 0.136 | | | | |

Table 11 and Table 12 show aspheric surface data of each lens in the camera optical lens 40 according to Example 4 of the present disclosure.

TABLE 11

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −3.1617E−01 | 1.4015E−02 | −4.4205E−02 | 1.3903E−01 | −2.4695E−01 | 2.7265E−01 | −1.8877E−01 |
| R2 | −1.7883E+01 | 1.8664E−02 | −1.0414E−01 | 3.5530E−01 | −7.4058E−01 | 9.6890E−01 | −7.9560E−01 |
| R3 | 2.1161E+01 | −2.9099E−02 | 6.7312E−02 | −1.7372E−01 | 3.7208E−01 | −4.7884E−01 | 3.8786E−01 |
| R4 | 2.4646E+01 | −2.8832E−02 | 9.0370E−02 | −2.9250E−01 | 7.0164E−01 | −1.0064E+00 | 8.6022E−01 |
| R5 | 8.7571E+01 | −2.0630E−02 | −2.3835E−02 | 9.2687E−02 | −4.2597E−01 | 1.0526E+00 | −1.5506E+00 |
| R6 | 1.5936E+02 | −2.9694E−02 | −1.8499E−02 | 6.7095E−02 | −1.2024E−01 | 2.1775E−02 | 1.3466E−01 |
| R7 | 7.9788E+01 | −1.0654E−01 | −8.8528E−02 | 4.8555E−01 | −1.1862E+00 | 1.6425E+00 | −1.3599E+00 |
| R8 | −1.4059E+01 | −9.3938E−02 | −7.8387E−02 | 3.8045E−01 | −7.6792E−01 | 8.9180E−01 | −6.3191E−01 |
| R9 | 2.6576E+02 | −1.0479E−01 | 6.3220E−02 | −4.8422E−02 | 2.2262E−02 | −1.0078E−02 | 7.9601E−03 |
| R10 | −9.8645E+03 | −1.7932E−01 | 8.7407E−02 | −1.1464E−03 | −4.6866E−02 | 4.1831E−02 | −1.8082E−02 |
| R11 | −8.0400E−01 | −9.0521E−02 | −6.4313E−03 | 2.1082E−02 | −2.4083E−02 | 1.5370E−02 | −6.1477E−03 |
| R12 | 1.9542E+01 | 5.3074E−02 | −7.6347E−02 | 4.1428E−02 | −1.7101E−02 | 5.5598E−03 | −1.3377E−03 |
| R13 | −1.0250E+00 | 1.3480E−01 | −8.7327E−02 | 5.4239E−02 | −2.3296E−02 | 6.9747E−03 | −1.5084E−03 |
| R14 | −2.9252E−01 | 6.8552E−02 | −4.4064E−02 | 2.2669E−02 | −8.4534E−03 | 2.3022E−03 | −4.6050E−04 |

TABLE 12

| | Aspheric Coefficient | | | | | | | |
|---|---|---|---|---|---|---|---|---|
| | A16 | A18 | A20 | A22 | A24 | A26 | A28 | A30 |
| R1 | 8.0356E−02 | −1.8718E−02 | 1.8292E−03 | 0.0000E+00 | 0.0000E+00 | 0.0000E+00 | 0.0000E+00 | 0.0000E+00 |
| R2 | 3.9743E−01 | −1.1052E−01 | 1.3079E−02 | 0.0000E+00 | 0.0000E+00 | 0.0000E+00 | 0.0000E+00 | 0.0000E+00 |
| R3 | −1.9752E−01 | 5.7629E−02 | −7.3622E−03 | 0.0000E+00 | 0.0000E+00 | 0.0000E+00 | 0.0000E+00 | 0.0000E+00 |
| R4 | −4.0650E−01 | 7.9971E−02 | 1.1996E−03 | 0.0000E+00 | 0.0000E+00 | 0.0000E+00 | 0.0000E+00 | 0.0000E+00 |
| R5 | 1.3332E+00 | −6.2017E−01 | 1.2146E−01 | 0.0000E+00 | 0.0000E+00 | 0.0000E+00 | 0.0000E+00 | 0.0000E+00 |
| R6 | −1.6358E−01 | 7.9640E−02 | −1.4409E−02 | 0.0000E+00 | 0.0000E+00 | 0.0000E+00 | 0.0000E+00 | 0.0000E+00 |
| R7 | 6.3976E−01 | −1.5004E−01 | 1.2232E−02 | 0.0000E+00 | 0.0000E+00 | 0.0000E+00 | 0.0000E+00 | 0.0000E+00 |
| R8 | 2.6785E−01 | −6.1453E−02 | 5.8411E−03 | 0.0000E+00 | 0.0000E+00 | 0.0000E+00 | 0.0000E+00 | 0.0000E+00 |
| R9 | −4.8023E−03 | 1.3653E−03 | −1.4072E−04 | 0.0000E+00 | 0.0000E+00 | 0.0000E+00 | 0.0000E+00 | 0.0000E+00 |
| R10 | 4.3030E−03 | −5.4199E−04 | 2.8365E−05 | 0.0000E+00 | 0.0000E+00 | 0.0000E+00 | 0.0000E+00 | 0.0000E+00 |
| R11 | 1.7079E−03 | −3.4674E−04 | 5.2120E−05 | −5.7293E−06 | 4.4579E−07 | −2.3149E−08 | 7.1664E−10 | −9.9674E−12 |
| R12 | 2.3081E−04 | −2.8163E−05 | 2.3803E−06 | −1.3317E−07 | 4.4955E−09 | −7.5578E−11 | 4.9691E−13 | −9.4728E−15 |
| R13 | 2.4105E−04 | −2.8743E−05 | 2.5527E−06 | −1.6651E−07 | 7.7431E−09 | −2.4277E−10 | 4.5954E−12 | −3.9633E−14 |
| R14 | 6.7590E−05 | −7.2503E−06 | 5.6385E−07 | −3.1300E−08 | 1.2045E−09 | −3.0423E−11 | 4.5184E−13 | −2.9761E−15 |

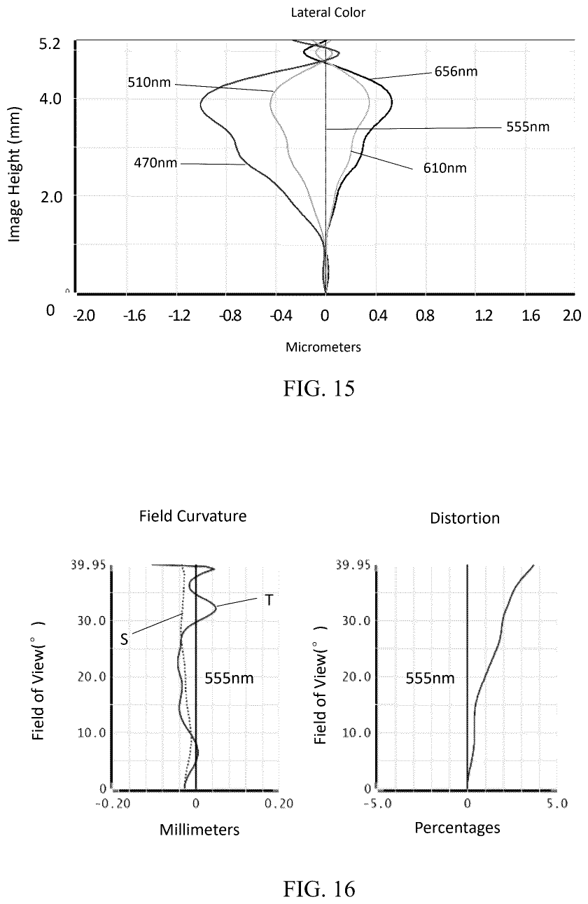

FIG. 14 and FIG. 15 show longitudinal aberration and lateral color of light with wavelengths of 656 nm, 610 nm, 555 nm, 510 nm and 470 nm after passing the camera optical lens 40 according to Example 4. FIG. 16 shows field curvature and distortion of light with a wavelength of 555 nm after passing through the camera optical lens 40 according to Example 4, the field curvature S in FIG. 16 is a field curvature in the sagittal direction, and T is a field curvature in the meridian direction.

In this Example, the entrance pupil diameter ENPD of the camera optical lens 40 is 2.714 mm, the image height IH at 1.0 field of view is 5.202 mm, the field of view FOV at the 1.0 field of view is 79.91°, the image height IHm at MIC field of view is 5.433 mm, and the field of view FOVm at MIC field of view is 82.27°. The camera optical lens 40 meets the design requirements of large aperture, wide-angle and ultra-thinness, effectively correcting both the on-axis and off-axis chromatic aberrations thereof, and has excellent optical characteristics.

### Example 5

The meaning of the reference signs of Example 5 is the same as that of Example 1.

It differs from Example 1 that: an image-side surface of the third lens L3 is convex in a paraxial region, and the fifth lens L5 has positive refractive power.

FIG. 17 shows a camera optical lens 50 according to Example 5 of the present disclosure.

Table 13 shows design data of the camera optical lens 50 according to Example 5 of the present disclosure.

TABLE 13

| | R | d | | nd | | νd | |
|---|---|---|---|---|---|---|---|
| S1 | ∞ | d0 = | −0.601 | | | | |
| R1 | 1.798 | d1 = | 0.703 | nd1 | 1.4959 | ν1 | 81.64 |
| R2 | 5.253 | d2 = | 0.277 | | | | |
| R3 | 10.180 | d3 = | 0.218 | nd2 | 1.6700 | ν2 | 19.39 |
| R4 | 6.886 | d4 = | 0.198 | | | | |
| R5 | 24.419 | d5 = | 0.366 | nd3 | 1.5444 | ν3 | 55.82 |
| R6 | −498.912 | d6 = | 0.254 | | | | |
| R7 | 12.383 | d7 = | 0.234 | nd4 | 1.6700 | ν4 | 19.39 |
| R8 | 6.742 | d8 = | 0.392 | | | | |
| R9 | −779.075 | d9 = | 0.508 | nd5 | 1.5661 | ν5 | 37.71 |
| R10 | −231.834 | d10 = | 0.313 | | | | |
| R11 | 2.361 | d11 = | 0.550 | nd6 | 1.5444 | ν6 | 55.82 |
| R12 | 253.918 | d12 = | 0.624 | | | | |
| R13 | −1.221 | d13 = | 0.422 | nd7 | 1.5444 | ν7 | 55.82 |
| R14 | −6.049 | d14 = | 0.260 | | | | |
| R15 | ∞ | d15 = | 0.110 | ndg | 1.5168 | νg | 64.17 |
| R16 | ∞ | d16 = | 0.410 | | | | |

Table 14 and Table 15 show aspheric surface data of each lens in the camera optical lens 50 according to Example 5 of the present disclosure.

TABLE 14

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −2.7025E−01 | 1.8106E−02 | −4.6804E−02 | 1.3943E−01 | −2.4590E−01 | 2.7391E−01 | −1.9071E−01 |
| R2 | −1.6704E+01 | 2.3400E−02 | −1.0358E−01 | 3.5207E−01 | −7.4083E−01 | 9.6846E−01 | −7.9476E−01 |
| R3 | −3.3910E+00 | −3.2551E−02 | 6.3650E−02 | −1.7684E−01 | 3.7282E−01 | −4.7708E−01 | 3.8926E−01 |
| R4 | 2.0181E+01 | −3.5700E−02 | 8.7251E−02 | −2.8965E−01 | 6.9851E−01 | −1.0043E+00 | 8.6356E−01 |
| R5 | 3.2590E+01 | −2.1383E−02 | −2.3947E−02 | 9.0796E−02 | −4.2324E−01 | 1.0565E+00 | −1.5543E+00 |
| R6 | −6.8655E+02 | −3.2013E−02 | −2.2328E−02 | 6.9601E−02 | −1.1296E−01 | 1.3934E−02 | 1.3606E−01 |
| R7 | −1.3296E+01 | −1.1380E−01 | −8.9711E−02 | 4.8323E−01 | −1.1809E+00 | 1.6392E+00 | −1.3581E+00 |
| R8 | −1.7510E+01 | −9.6870E−02 | −7.8318E−02 | 3.7905E−01 | −7.6362E−01 | 8.8877E−01 | −6.3208E−01 |
| R9 | −5.3140E+03 | −9.4846E−02 | 6.1386E−02 | −4.6056E−02 | 2.1248E−02 | −1.0302E−02 | 8.0788E−03 |
| R10 | 1.1049E+02 | −1.9377E−01 | 8.9937E−02 | −7.0080E−04 | −4.6833E−02 | 4.1823E−02 | −1.8082E−02 |
| R11 | −1.1448E+00 | −9.7502E−02 | −6.0879E−03 | 2.1271E−02 | −2.4118E−02 | 1.5372E−02 | −6.1477E−03 |
| R12 | 3.1129E+00 | 5.9642E−02 | −7.7267E−02 | 4.1536E−02 | −1.7109E−02 | 5.5583E−03 | −1.3376E−03 |
| R13 | −1.0016E+00 | 1.3539E−01 | −8.7017E−02 | 5.4229E−02 | −2.3296E−02 | 6.9747E−03 | −1.5084E−03 |
| R14 | 2.9241E−02 | 5.7881E−02 | −4.3525E−02 | 2.2622E−02 | −8.4532E−03 | 2.3026E−03 | −4.6051E−04 |

TABLE 15

| | Aspheric Coefficient | | | | | | | |
|---|---|---|---|---|---|---|---|---|
| | A16 | A18 | A20 | A22 | A24 | A26 | A28 | A30 |
| R1 | 8.0356E−02 | −1.8718E−02 | 1.8292E−03 | 0.0000E+00 | 0.0000E+00 | 0.0000E+00 | 0.0000E+00 | 0.0000E+00 |
| R2 | 3.9743E−01 | −1.1052E−01 | 1.3079E−02 | 0.0000E+00 | 0.0000E+00 | 0.0000E+00 | 0.0000E+00 | 0.0000E+00 |
| R3 | −1.9752E−01 | 5.7629E−02 | −7.3622E−03 | 0.0000E+00 | 0.0000E+00 | 0.0000E+00 | 0.0000E+00 | 0.0000E+00 |
| R4 | −4.0650E−01 | 7.9971E−02 | 1.1996E−03 | 0.0000E+00 | 0.0000E+00 | 0.0000E+00 | 0.0000E+00 | 0.0000E+00 |
| R5 | 1.3332E+00 | −6.2017E−01 | 1.2146E−01 | 0.0000E+00 | 0.0000E+00 | 0.0000E+00 | 0.0000E+00 | 0.0000E+00 |
| R6 | −1.6358E−01 | 7.9640E−02 | −1.4409E−02 | 0.0000E+00 | 0.0000E+00 | 0.0000E+00 | 0.0000E+00 | 0.0000E+00 |
| R7 | 6.3976E−01 | −1.5004E−01 | 1.2232E−02 | 0.0000E+00 | 0.0000E+00 | 0.0000E+00 | 0.0000E+00 | 0.0000E+00 |
| R8 | 2.6785E−01 | −6.1453E−02 | 5.8411E−03 | 0.0000E+00 | 0.0000E+00 | 0.0000E+00 | 0.0000E+00 | 0.0000E+00 |
| R9 | −4.8023E−03 | 1.3653E−03 | −1.4072E−04 | 0.0000E+00 | 0.0000E+00 | 0.0000E+00 | 0.0000E+00 | 0.0000E+00 |
| R10 | 4.3030E−03 | −5.4199E−04 | 2.8365E−05 | 0.0000E+00 | 0.0000E+00 | 0.0000E+00 | 0.0000E+00 | 0.0000E+00 |
| R11 | 1.7079E−03 | −3.4674E−04 | 5.2120E−05 | −5.7293E−06 | 4.4579E−07 | −2.3149E−08 | 7.1664E−10 | −9.9674E−12 |
| R12 | 2.3081E−04 | −2.8163E−05 | 2.3803E−06 | −1.3317E−07 | 4.4955E−09 | −7.5578E−11 | 4.9691E−13 | −9.4728E−15 |
| R13 | 2.4105E−04 | −2.8743E−05 | 2.5527E−06 | −1.6651E−07 | 7.7431E−09 | −2.4277E−10 | 4.5954E−12 | −3.9633E−14 |
| R14 | 6.7590E−05 | −7.2503E−06 | 5.6385E−07 | −3.1300E−08 | 1.2045E−09 | −3.0423E−11 | 4.5184E−13 | −2.9761E−15 |

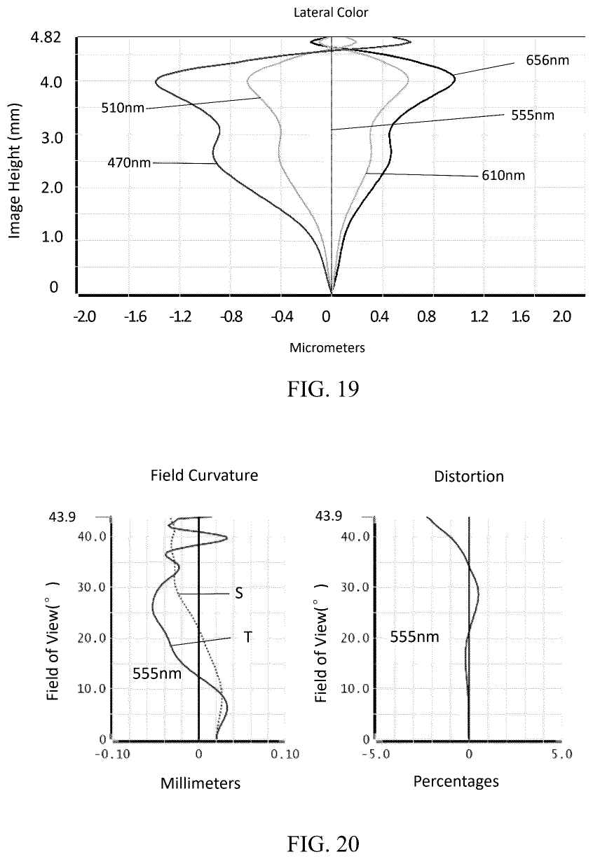

FIG. 18 and FIG. 19 show longitudinal aberration and lateral color of light with wavelengths of 656 nm, 610 nm, 555 nm, 510 nm and 470 nm after passing the camera optical lens 50 according to Example 5. FIG. 20 shows field curvature and distortion of light with a wavelength of 555 nm after passing through the camera optical lens 50 according to Example 5, the field curvature S in FIG. 20 is a field curvature in the sagittal direction, and T is a field curvature in the meridian direction.

In this Example, the entrance pupil diameter ENPD of the camera optical lens 50 is 2.714 mm, the image height IH at 1.0 field of view is 4.816 mm, the field of view FOV at the 1.0 field of view is 87.73°, the image height IHm at MIC field of view is 4.992 mm, and the field of view FOVm at MIC field of view is 90.06°. The camera optical lens 50 meets the design requirements of large aperture, wide-angle and ultra-thinness, effectively correcting both the on-axis and off-axis chromatic aberrations thereof, and has excellent optical characteristics.

Table 19 shows values of various values in Example 1, Example 2, Example 3, Example 4 and Example 5 corresponding to parameters specified in the relational expressions.

### Comparative Example

The meaning of the reference signs of Comparative Example is the same as that of Example 1.

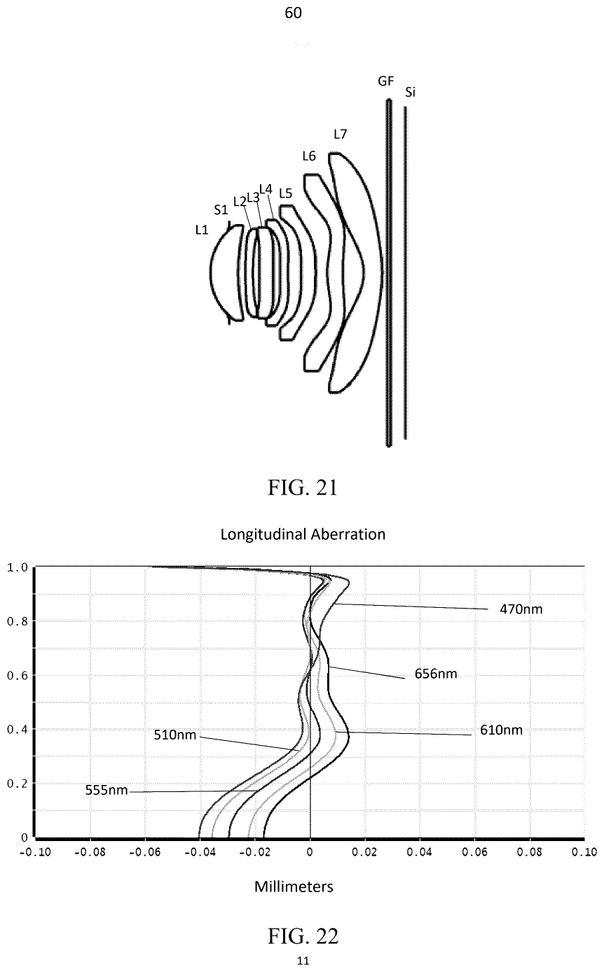

FIG. 21 shows a camera optical lens 60 according to Comparative Example.

Table 16 shows design data of the camera optical lens 60 according to Comparative Example.

TABLE 16

| | R | d | | nd | | νd | |
|---|---|---|---|---|---|---|---|
| S1 | ∞ | d0 = | −0.592 | | | | |
| R1 | 1.782 | d1 = | 0.873 | nd1 | 1.4959 | ν1 | 81.64 |
| R2 | 5.554 | d2 = | 0.227 | | | | |
| R3 | 10.013 | d3 = | 0.236 | nd2 | 1.6700 | ν2 | 19.39 |
| R4 | 6.153 | d4 = | 0.195 | | | | |
| R5 | 20.136 | d5 = | 0.447 | nd3 | 1.5444 | ν3 | 55.82 |
| R6 | 33.932 | d6 = | 0.215 | | | | |
| R7 | 15.343 | d7 = | 0.248 | nd4 | 1.6700 | ν4 | 19.39 |
| R8 | 8.509 | d8 = | 0.411 | | | | |
| R9 | −59.571 | d9 = | 0.454 | nd5 | 1.5661 | ν5 | 37.71 |
| R10 | −44.018 | d10 = | 0.364 | | | | |
| R11 | 2.471 | d11 = | 0.488 | nd6 | 1.5444 | ν6 | 55.82 |
| R12 | 10.429 | d12 = | 0.661 | | | | |
| R13 | −1.264 | d13 = | 0.577 | nd7 | 1.5444 | ν7 | 55.82 |
| R14 | −3.764 | d14 = | 0.160 | | | | |
| R15 | ∞ | d15 = | 0.110 | ndg | 1.5168 | νg | 64.17 |
| R16 | ∞ | d16 = | 0.467 | | | | |

Table 17 and Table 18 show aspheric surface data of each lens in the camera optical lens 60 as described in Comparative Example of the present disclosure.

TABLE 17

| | Conic | | | | | | |
|---|---|---|---|---|---|---|---|
| | Coefficient | Aspheric Coefficient | | | | | |
| | k | A4 | A6 | A8 | A10 | A12 | A14 |
| R1 | −2.8899E−01 | 1.4129E−02 | −4.0034E−02 | 1.3490E−01 | −2.4554E−01 | 2.7506E−01 | −1.9096E−01 |
| R2 | −1.6955E+01 | 2.1416E−02 | −1.0381E−01 | 3.5477E−01 | −7.4138E−01 | 9.6811E−01 | −7.9481E−01 |
| R3 | 2.2771E+01 | −3.4019E−02 | 6.7377E−02 | −1.8029E−01 | 3.7255E−01 | −4.7600E−01 | 3.8952E−01 |
| R4 | 1.8380E+01 | −3.3997E−02 | 8.5958E−02 | −2.8809E−01 | 6.9602E−01 | −1.0030E+00 | 8.6235E−01 |
| R5 | 1.3871E+01 | −2.4924E−02 | −1.3262E−02 | 8.0740E−02 | −4.2244E−01 | 1.0628E+00 | −1.5540E+00 |
| R6 | −2.0822E+03 | −2.4119E−02 | −1.9957E−02 | 7.0203E−02 | −1.0898E−01 | 9.0884E−03 | 1.3733E−01 |
| R7 | −5.0208E+00 | −1.0930E−01 | −8.3852E−02 | 4.8337E−01 | −1.1817E+00 | 1.6399E+00 | −1.3587E+00 |
| R8 | −2.8850E+01 | −9.4883E−02 | −7.8574E−02 | 3.7919E−01 | −7.6285E−01 | 8.8806E−01 | −6.3220E−01 |
| R9 | 9.6896E+02 | −1.0982E−01 | 6.4576E−02 | −4.6469E−02 | 2.0763E−02 | −1.0125E−02 | 8.0556E−03 |
| R10 | −2.4104E+03 | −1.8328E−01 | 8.7350E−02 | −4.2943E−04 | −4.6803E−02 | 4.1824E−02 | −1.8081E−02 |
| R11 | −9.8310E−01 | −9.3729E−02 | −7.1569E−03 | 2.1348E−02 | −2.4098E−02 | 1.5369E−02 | −6.1477E−03 |
| R12 | −8.1598E+01 | 5.4092E−02 | −7.6157E−02 | 4.1521E−02 | −1.7116E−02 | 5.5585E−03 | −1.3376E−03 |
| R13 | −9.8995E−01 | 1.3548E−01 | −8.7144E−02 | 5.4234E−02 | −2.3296E−02 | 6.9747E−03 | −1.5084E−03 |
| R14 | −6.3831E−02 | 6.4874E−02 | −4.3743E−02 | 2.2632E−02 | −8.4539E−03 | 2.3026E−03 | −4.6051E−04 |

TABLE 18

| | Aspheric Coefficient | | | | | | | |
|---|---|---|---|---|---|---|---|---|
| | A16 | A18 | A20 | A22 | A24 | A26 | A28 | A30 |
| R1 | 8.0216E−02 | −1.8665E−02 | 1.8423E−03 | 0.0000E+00 | 0.0000E+00 | 0.0000E+00 | 0.0000E+00 | 0.0000E+00 |
| R2 | 3.9760E−01 | −1.1042E−01 | 1.3020E−02 | 0.0000E+00 | 0.0000E+00 | 0.0000E+00 | 0.0000E+00 | 0.0000E+00 |
| R3 | −1.9816E−01 | 5.7314E−02 | −7.0632E−03 | 0.0000E+00 | 0.0000E+00 | 0.0000E+00 | 0.0000E+00 | 0.0000E+00 |
| R4 | −4.0593E−01 | 7.9620E−02 | 1.6057E−03 | 0.0000E+00 | 0.0000E+00 | 0.0000E+00 | 0.0000E+00 | 0.0000E+00 |
| R5 | 1.3270E+00 | −6.1598E−01 | 1.2045E−01 | 0.0000E+00 | 0.0000E+00 | 0.0000E+00 | 0.0000E+00 | 0.0000E+00 |
| R6 | −1.6266E−01 | 7.9584E−02 | −1.4580E−02 | 0.0000E+00 | 0.0000E+00 | 0.0000E+00 | 0.0000E+00 | 0.0000E+00 |
| R7 | 6.4024E−01 | −1.5063E−01 | 1.2532E−02 | 0.0000E+00 | 0.0000E+00 | 0.0000E+00 | 0.0000E+00 | 0.0000E+00 |
| R8 | 2.6794E−01 | −6.1379E−02 | 5.8087E−03 | 0.0000E+00 | 0.0000E+00 | 0.0000E+00 | 0.0000E+00 | 0.0000E+00 |
| R9 | −4.7714E−03 | 1.3458E−03 | −1.3712E−04 | 0.0000E+00 | 0.0000E+00 | 0.0000E+00 | 0.0000E+00 | 0.0000E+00 |
| R10 | 4.3032E−03 | −5.4196E−04 | 2.8330E−05 | 0.0000E+00 | 0.0000E+00 | 0.0000E+00 | 0.0000E+00 | 0.0000E+00 |
| R11 | 1.7079E−03 | −3.4674E−04 | 5.2120E−05 | −5.7293E−06 | 4.4579E−07 | −2.3149E−08 | 7.1670E−10 | −9.9713E−12 |
| R12 | 2.3081E−04 | −2.8163E−05 | 2.3803E−06 | −1.3317E−07 | 4.4955E−09 | −7.5567E−11 | 4.9823E−13 | −9.4546E−15 |
| R13 | 2.4105E−04 | −2.8743E−05 | 2.5527E−06 | −1.6651E−07 | 7.7431E−09 | −2.4277E−10 | 4.5954E−12 | −3.9633E−14 |
| R14 | 6.7590E−05 | −7.2503E−06 | 5.6385E−07 | −3.1300E−08 | 1.2045E−09 | −3.0423E−11 | 4.5184E−13 | −2.9759E−15 |

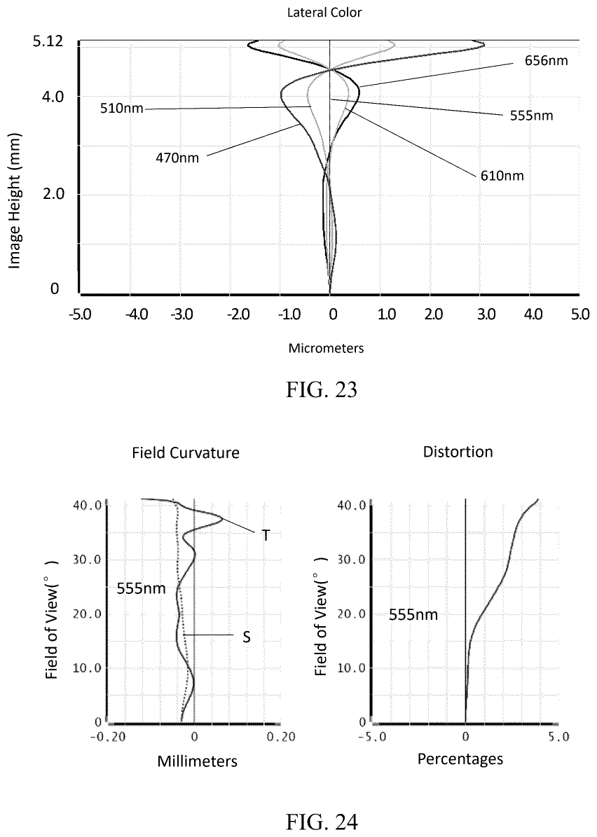

FIG. 22 and FIG. 23 respectively show longitudinal aberration and lateral color of light with wavelengths of 656 nm, 610 nm, 555 nm, 510 nm, and 470 nm after passing through the camera optical lens 60 according to Comparative Example. FIG. 24 shows field curvature and distortion of light with a wavelength of 555 nm after passing through the camera optical lens 60 according to Comparative Example, the field curvature S in FIG. 24 is a field curvature in the sagittal direction, and T is a field curvature in the meridian direction.

Table 19 below lists values corresponding to each relational expression in Comparative Example according to the above relational expressions. The camera optical lens 60 of Comparative Example does not satisfy the above relational expression 1.40≤(f6-f7)/f≤1.70.

In the Comparative Example, the entrance pupil diameter ENPD of the camera optical lens 60 is 2.714 mm, the image height IH at 1.0 field of view is 5.120 mm, the field of view FOV at 1.0 field of view is 82.47°, the image height at MIC field of view IHm is 5.335 mm, and the field of view at MIC field of view FOVm is 84.74°. The camera optical lens 60 does not satisfy the design requirements of the large aperture, wide-angle and ultra-thinness.

TABLE 19

| Parameters and | | | | | | |
|---|---|---|---|---|---|---|
| Relational | | | | | | Comparative |
| Expressions | Example 1 | Example 2 | Example 3 | Example 4 | Example 5 | Example |
| (f6 − f7)/f | 1.570 | 1.408 | 1.580 | 1.674 | 1.403 | 1.723 |
| R14/R13 | 3.410 | 2.922 | 2.019 | 2.684 | 4.955 | 2.977 |
| v1 | 81.640 | 81.640 | 60.077 | 81.640 | 81.640 | 81.640 |
| f | 5.130 | 6.395 | 7.736 | 5.944 | 5.166 | 5.571 |
| f1 | 5.269 | 5.027 | 5.401 | 5.121 | 5.154 | 4.901 |
| f2 | −35.376 | −14.988 | −50.996 | −27.417 | −32.337 | −24.205 |
| f3 | 45.243 | 48.129 | −47.034 | 82.245 | 42.634 | 89.651 |
| f4 | −24.394 | −32.979 | −16.455 | −32.401 | −22.256 | −28.671 |
| f5 | −294.412 | −65.026 | −107.325 | −116.752 | 580.040 | 293.297 |
| f6 | 4.670 | 4.973 | 5.321 | 5.629 | 4.360 | 5.804 |
| f7 | −3.384 | −4.034 | −6.906 | −4.324 | −2.889 | −3.795 |
| FNO | 1.890 | 2.356 | 2.850 | 2.190 | 1.903 | 2.057 |
| TTL | 5.850 | 6.809 | 8.103 | 6.460 | 5.839 | 6.133 |
| IH | 5.120 | 4.985 | 4.750 | 5.202 | 4.816 | 5.120 |
| FOV | 88.30 | 75.82 | 64.15 | 79.91 | 87.73 | 82.47 |

Those skilled in the art may understand that the above Examples are specific Examples for implementing the present disclosure, and in practical applications, various changes may be made in form and detail without departing from the spirit and scope of the present disclosure.

What is claimed is:

1. A camera optical lens, comprising seven lenses sequentially from an object side to an image side: a first lens with positive refractive power, a second lens with negative refractive power, a third lens, a fourth lens with negative refractive power, a fifth lens, a sixth lens with positive refractive power, and a seventh lens with negative refractive power; a focal length of the camera optical lens is f, a focal length of the sixth lens is f6, a focal length of the seventh lens is f7, a central curvature radius of an object-side surface of the seventh lens is R13, a central curvature radius of an image-side surface of the seventh lens is R14, an Abbe number of the first lens is v1, and following relational expressions are satisfied:
$$1.4 \leq ( f 6 - f 7 ) / f \leq 1.7 ; \\ 2. \leq R 14 / R 13 \leq 6. ; and \\ 60. \leq v 1 \leq 82.00 .$$

2. The camera optical lens as described in claim 1, wherein a central curvature radius of an object-side surface of the second lens is R3, a central curvature radius of an image-side surface of the second lens is R4, and a following relational expression is satisfied:
$$2.3 \leq ( R 3 + R 4 ) / ( R 3 - R 4 ) \leq 10.00 .$$

3. The camera optical lens as described in claim 1, wherein an on-axis thickness of the third lens is d5, an on-axis thickness of the fourth lens is d7, and a following relational expression is satisfied:
$$0.8 \leq d 5 / d 7 \leq 2 \text{.00} .$$

4. The camera optical lens as described in claim 1, wherein an object-side surface of the first lens is convex in a paraxial region, and an image-side surface of the first lens is concave in the paraxial region;
a focal length of the first lens is f1, a central curvature radius of the object-side surface of the first lens is R1, a central curvature radius of the image-side surface of the first lens is R2, an on-axis thickness of the first lens is d1, a total optical length from the object-side surface of the first lens to an image plane of the camera optical lens along an optic axis of the camera optical lens is TTL, and following relational expressions are satisfied:
$$0.69 \leq f 1 / f \leq 1.03 ; \\ - 2.66 \leq ( R 1 + R 2 ) / ( R 1 - R 2 ) \leq - 1.84 ; and$$
$$0.07 \leq d 1 / TTL \leq 0.15 .$$

5. The camera optical lens as described in claim 1, wherein an object-side surface of the second lens is convex in a paraxial region, and an image-side surface of the second lens is concave in the paraxial region;
a focal length of the second lens is f2, an on-axis thickness of the second lens is d3, a total optical length from an object-side surface of the first lens to an image plane of the camera optical lens along an optic axis of the camera optical lens is TTL, and following relations are satisfied:
$$- 6.90 \leq f 2 / f \leq - 2 \text{.34} ; and \\ 0.03 \leq d 3 / TTL \leq 0.04 .$$

6. The camera optical lens as described in claim 1, wherein a focal length of the third lens is f3, a central curvature radius of an object-side surface of the third lens is R5, a central curvature radius of an image-side surface of the third lens is R6, an on-axis thickness of the third lens is d5, a total optical length from an object-side surface of the first lens to an image plane of the camera optical lens along an optic axis of the camera optical lens is TTL, and following relations are satisfied:
$$- 6.08 \leq f 3 / f \leq 13.84 ; \\ - 5.96 \leq ( R 5 + R 6 ) / ( R 5 - R 6 ) \leq - 0 \text{.74} ; and \\ 0.03 \leq d 5 / TTL \leq 0.08 .$$

7. The camera optical lens as described in claim 1, wherein an image-side surface of the fourth lens is concave in a paraxial region, and
a focal length of the fourth lens is f4, a central curvature radius of an object-side surface of the fourth lens is R7, a central curvature radius of the image-side surface of the fourth lens is R8, an on-axis thickness of the fourth lens is d7, a total optical length from an object-side surface of the first lens to an image plane of the camera optical lens along an optic axis of the camera optical lens is TTL, and following relations are satisfied:
$$- 5.46 \leq f 4 / f \leq - 2 \text{.12} ; \\ 0.81 \leq ( R 7 + R 8 ) / ( R 7 - R 8 ) \leq 3.77 ; and \\ 0.02 \leq d 7 / TTL \leq 0.05 .$$

8. The camera optical lens as described in claim 1, wherein an object-side surface of the fifth lens is concave in a paraxial region, and an image-side surface of the fifth lens is convex in the paraxial region;
a focal length of the fifth lens is f5, a central curvature radius of an object-side surface of the fifth lens is R9, a central curvature radius of an image-side surface of the fifth lens is R10, an on-axis thickness of the fifth lens is d9, a total optical length from an object-side surface of the first lens to an image plane of the camera optical lens along an optic axis of the camera optical lens is TTL, and following relations are satisfied:
$$- 57.40 \leq f 5 / f \leq 112.29 ; \\ - 3.61 \leq ( R 9 + R 10 ) / ( R 9 - R 10 ) \leq 1.85 ; and \\ 0.06 \leq d 9 / TTL \leq 0.09 .$$

9. The camera optical lens as described in claim 1, wherein an object-side surface of the sixth lens is convex in a paraxial region, and an image-side surface of the sixth lens is concave in the paraxial region, and
a central curvature radius of an object-side surface of the sixth lens is R11, a central curvature radius of an image-side surface of the sixth lens is R12, an on-axis thickness of the sixth lens is d11, a total optical length from an object-side surface of the first lens to an image plane of the camera optical lens along an optic axis of the camera optical lens is TTL, and following relations are satisfied:
$$0.68 \leq f 6 / f \leq 0 \text{.95} ; \\ - 1.41 \leq ( R 11 + R 12 ) / ( R 11 - R 12 ) \leq - 1.01 ; and \\ 0.01 \leq d 11 / TTL \leq 0.62 .$$

10. The camera optical lens as described in claim 1, wherein the object-side surface of the seventh lens is concave in a paraxial region, and the image-side surface of the seventh lens is convex in the paraxial region; and
an on-axis thickness of the seventh lens is d13, a total optical length from an object-side surface of the first lens to an image plane of the camera optical lens along an optic axis of the camera optical lens is TTL, and following relations are satisfied:
$$- 0.90 \leq f 7 / f \leq - 0 \text{.55} ; \\ - 2.97 \leq ( R 13 + R 14 ) / ( R 13 - R 14 ) \leq - 1.5 ; and \\ 0.07 \leq d 13 / TTL \leq 0.14 .$$

11. The camera optical lens as described in claim 1, wherein the second lens is made of glass.
